(19) United States
(12) Patent Application Publication
(10) Pub. No.: US 2016/0334822 A1
(43) Pub. Date: Nov. 17, 2016

(54) POWER ROUTER AND METHOD FOR CONTROLLING SAME, COMPUTER-READABLE MEDIUM, AND POWER NETWORK SYSTEM

(71) Applicant: NEC CORPORATION, Tokyo (JP)

(72) Inventor: Noriaki KOBAYASHI, Tokyo (JP)

(21) Appl. No.: 15/111,665

(22) PCT Filed: Dec. 5, 2014
(86) PCT No.: PCT/JP2014/006093

§ 371 Date: Jul. 14, 2016

(30) Foreign Application Priority Data
Jan. 15, 2014 (JP) 2014-004919

(51) Int. Cl. G05F 1/66; H02J 3/38

(52) U.S. Cl. CPC G05F 1/66; H02J 3/382; H02J 3/383; H02J 3/386

(57) ABSTRACT

The purpose of the present invention is to enable a power router to be more suitably managed or controlled when constructing a power network system in which power cells are asynchronously interconnected. A power router has a first master leg, a second master leg, a first stand-alone leg, and a second stand-alone leg. Based on the power transmitted and received by the first stand-alone leg and the second stand-alone leg, a control unit controls the power transmitted and received by the first master leg and the power transmitted and received by the second master leg.

### TECHNICAL FIELD

The present invention relates to a power router and a control method thereof, a computer readable medium, and a power network system.

### BACKGROUND ART

For building a power supply system, it is a significant challenge to expand a power transmission network more stably and, moreover, configure a system capable of introducing a large amount of natural energy.

As a novel power network, a power network system called a digital grid (registered trademark) has been proposed (PTL 1 and PTL 2).

The digital grid (registered trademark) is a power network system in which a power network is divided into small-scale cells and the cells are asynchronously connected to one another. Each power cell which is small has a scale including one house, building, or commercial facility. Each power cell which is large has a scale including a prefecture, a city, a town, and a village. Each power cell includes a load and, in some cases, a power-generating facility and a power storing facility. An example of the power-generating facility is a power-generating facility using natural energy such as solar power generation, wind power generation, and geothermal power generation.

In order to allow free generation of power in each of the power cells and smooth interchange of power among the power cells, the power cells are asynchronously connected to one another. That is, even when a plurality of power cells are connected to one another, the voltage, phase, frequency of power used in each power cell are not synchronized with those of another power cell.

FIG. 20 is a diagram illustrating an example of a power network system 810. In FIG. 20, a utility grid 811 transmits base power from a large-scale power plant 812. A plurality of power cells 821 to 824 are arranged. Each of the power cells 821 to 824 has loads such as a house 831 and a building 832, power generating facilities (for example, a solar power panel 833 and a wind power generator 834), and a power storing facility (for example, a storage battery 835).

In addition, in the present specification, the power generating facilities and the power storing facilities will be also collectively called a “distributed power supply”.

Moreover, the power cells 821 to 824 have power routers 841 to 844, respectively, as connection ports to be connected to the other power cells or the utility grid 811. Each of the power routers 841 to 844 has a plurality of legs (The reference numerals of the legs are omitted in FIG. 20 because of limited space. Blank circles attached to the power routers 841 to 844 are to be understood as connection terminals of the legs.).

The legs have a connection terminal and a power conversion unit, and an address is assigned to each of the legs. Power conversion by a leg includes conversion from an alternating current to a direct current or from a direct current to an alternating current, and a change in the voltage, frequency, and phase of power.

All the power routers 841 to 844 are connected to a management server 850 via a communication network 860 and are controlled integrally by the management server 850. For example, the management server 850 instructs the power routers 841 to 844 to transmit or receive power by the legs. By the operation, power interchange is performed among the power cells via the power routers 841 to 844.

By realizing power interchange among the power cells, for example, one power generating facility (for example, the solar power panel 833 or the wind power generator 834) and one power storing facility (for example, the storage battery 835) can be commonly used by a plurality of power cells. When surplus power is interchanged among the power cells, while largely reducing the cost of the facilities, the power demand and supply balance can be stably maintained.

### CITATION LIST

### Patent Literature

PTL 1: Japanese Patent Publication No. 4783453

PTL 2: Japanese Patent Application Laid-open Publication No. 2011-182641

### SUMMARY OF INVENTION

### Technical Problem

Asynchronous connection of a plurality of cells through power routers, if realized, would offer great advantages, and strong expectations are placed on an early practical implementation of power routers.

However, putting power routers into practical use involves particular problems which are not associated with previous power transmission/distribution facilities. While a main power transmission/distribution facility at the present time is based on a power system in which voltage, phase, and frequency are completely synchronized, it is necessary to address new problems relating to power routers that interconnect power systems with different voltages, phases, and frequencies.

When designated power is transmitted and received among power routers, a reception-side power router may not receive power which corresponds to a target value for the power transmission received by a transmission-side power router. For example, depending on transmission loss of a transmission line, conversion efficiency, voltage and phase differences and the like, a value smaller (or larger) than the target value may be received in the reception-side power router.

An object of the present invention is to more appropriately manage power routers in building a power network system in which power cells are asynchronously connected to one another.

### Solution to Problem

A power router according to the one aspect of the present invention includes:

a plurality of master legs;

one or more legs other than the master legs; and

a control unit that controls power transmitted/received by each of the plurality of master legs based on power transmitted/received by the one or more legs other than the master legs.

A power network system according to the one aspect of the present invention includes:

a power router; and

a management server that controls power transmission and reception of the power router,

wherein the power router includes:

a plurality of master legs;

one or more legs other than the master legs; and

a control unit that controls power transmitted/received by each of the plurality of master legs based on power transmitted/received by the one or more legs other than the master legs, in response to an instruction from the management server.

A control method of a power router according to the one aspect of the present invention includes:

referring to power transmitted/received by one or more legs other than a master leg; and

controlling power transmitted/received by each of a plurality of master legs based on the power transmitted/received by the one or more legs other than the master leg.

A non-transitory computer readable medium storing a control program of a power router according to the one aspect of the present invention, the program causing a computer to perform:

a process of referring to power transmitted/received by one or more legs other than a master leg; and

a process of controlling power transmitted/received by each of a plurality of master legs based on the power transmitted/received by the one or more legs other than the master leg.

### Advantageous Effects of Invention

According to the present invention, it is possible to more appropriately manage or control power routers in building a power network system in which power cells are asynchronously connected to one another.

### BRIEF DESCRIPTION OF DRAWINGS

FIG. 1 is a block diagram illustrating a schematic configuration of a power network system 1000 according to an exemplary embodiment 1.

FIG. 2 is a block diagram of a power router 101, which illustrates an example of an internal structure of a leg.

FIG. 3 is a block diagram of a power router 101, which illustrates an internal structure of a leg in more detail.

FIG. 4 is a block diagram illustrating a configuration example of a power router 170 having an AC through leg 60.

FIG. 5 is a block diagram schematically illustrating a relation between a configuration of a control unit 19 and a leg.

FIG. 6 is a diagram illustrating an example that a power router is connected to a utility grid, a load, and various distributed supplies.

FIG. 7A is a diagram illustrating an example of a possible combination in a connection of power routers.

FIG. 7B is a diagram illustrating an example of a possible combination in a connection of power routers.

FIG. 8A is a diagram illustrating an example of a prohibited combination in a connection of power routers.

FIG. 8B is a diagram illustrating an example of a prohibited combination in a connection of power routers.

FIG. 8C is a diagram illustrating an example of a prohibited combination in a connection of power routers.

FIG. 8D is a diagram illustrating an example of a prohibited combination in a connection of power routers.

FIG. 9A is a diagram illustrating an example of a possible combination in a connection of power routers in consideration of an AC through leg.

FIG. 9B is a diagram illustrating an example of a possible combination in a connection of power routers in consideration of an AC through leg.

FIG. 9C is a diagram illustrating an example of a possible combination in a connection of power routers in consideration of an AC through leg.

FIG. 9D is a diagram illustrating an example of a possible combination in a connection of power routers in consideration of an AC through leg.

FIG. 10 is a diagram illustrating an example that a distance between a first power router 100 and a utility grid 1035 is long.

FIG. 11 is a table of combination patterns in a connection of power routers.

FIG. 12 illustrates an example of an interconnection of four power routers.

FIG. 13 is a block diagram illustrating a schematic configuration of a power network system 1000, which illustrates a configuration of a management server 1010.

FIG. 14 is a block diagram schematically illustrating a configuration of a power router 600 according to an exemplary embodiment 1.

FIG. 15 is a diagram illustrating a power router 600 when power received in a first stand-alone leg 63 is 2 kW (W1=2 kW) and power received in a second stand-alone leg 64 is 1 kW (W2=1 kW).

FIG. 16 is a diagram illustrating a power router 600 when power received in a first stand-alone leg 63 is 1 kW (W1=1 kW) and power received in a second stand-alone leg 64 is 1 kW (W2=1 kW).

FIG. 17 is a diagram illustrating a power router 600 when power received in a first stand-alone leg 63 is 2 kW (W1=−2 kW) and power received in a second stand-alone leg 64 is 1 kW (W2=−1 kW).

FIG. 18 is a diagram illustrating a power router 600 when power received in a first stand-alone leg 63 is 1 kW (W1=1 kW) and power received in a second stand-alone leg 64 is 1 kW (W2=−1 kW).

FIG. 19 is a block diagram schematically illustrating a configuration of a power router 700 according to an exemplary embodiment 2.

FIG. 20 is a diagram illustrating an example of a power network system 810.

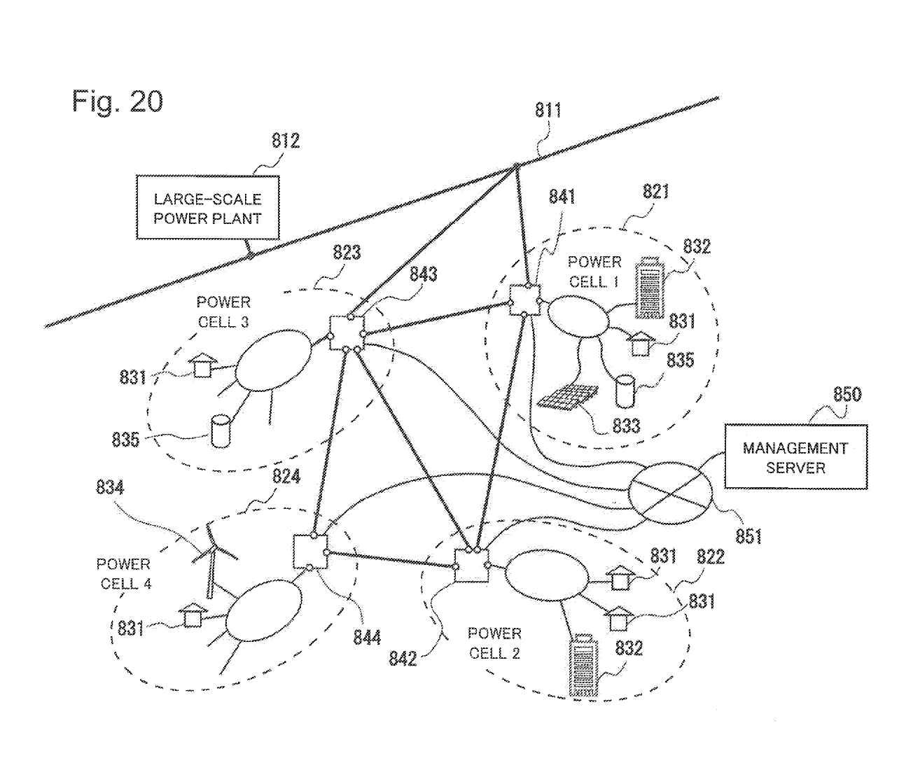

### DESCRIPTION OF EMBODIMENTS

Hereinafter, exemplary embodiments of the present invention will be described in detail with reference to the drawings. In the drawings, the same reference numerals are given to the same elements and repetitive description, if not necessary, will be omitted.

### Exemplary Embodiment 1

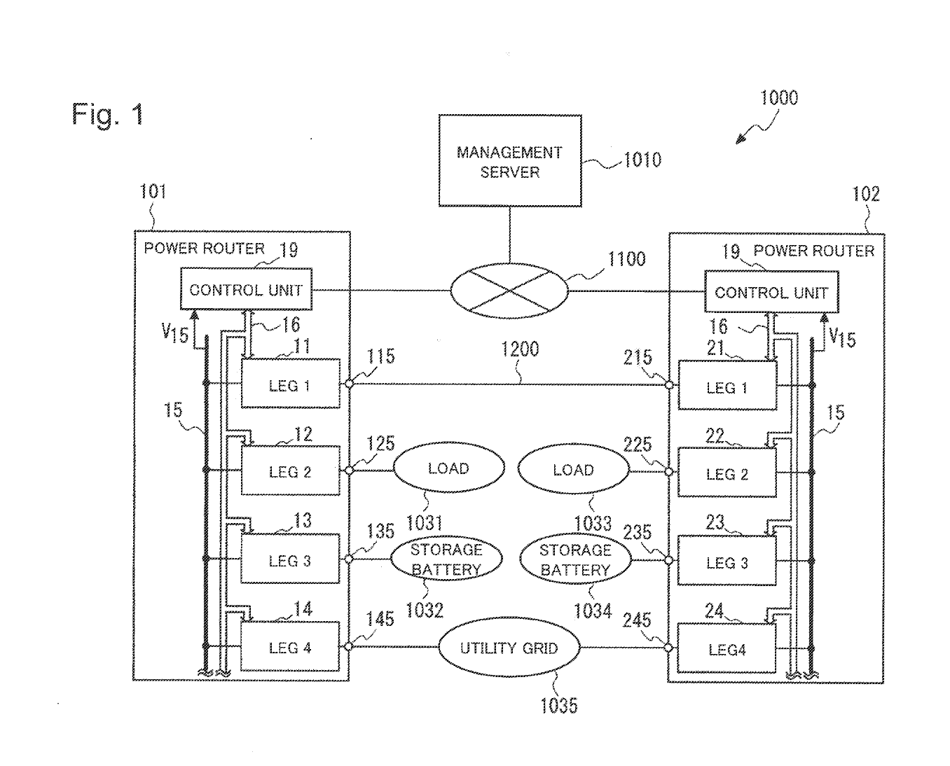

A power network system 1000 according to an exemplary embodiment 1 will be described. FIG. 1 is a block diagram illustrating a schematic configuration of the power network system 1000 according to the exemplary embodiment 1. The power network system 1000 has a management server 1010 and a plurality of power routers. In the present exemplary embodiment, an example in which the power network system 1000 having the management server 1010, power routers 101 and 102, and a transmission line 1200 will be described. The power routers 101 and 102 are specific examples of the above-described power routers 841 to 844 (see FIG. 23). Hereinafter, the management server is also called a management means.

The power network system 1000 and a power network system to be described in the following exemplary embodiment have a configuration for correcting power transmission loss between power routers by power control. In general, when power is transmitted via a transmission line, transmission loss occurs due to the length of a transmission path and the difference of a path. Therefore, even when a power transmission side transmits predetermined power, power received in a power reception side is lower than the output power of the power transmission side. Thus, the power network system 1000 and the power network system to be described in the following exemplary embodiment have a function of controlling the output power of the power transmission side such that power received in the power reception side reaches an appropriate value.

The power router 101 has, roughly, a DC bus 15, a communication bus 16, a first leg 11, a second leg 12, a third leg 13, a fourth leg 14, and a control unit 19. In the drawing, because of limited space, the first leg to the fourth leg are indicated by a leg 1 to a leg 4, respectively. The first leg 11, the second leg 12, the third leg 13, and the fourth leg 14 are connected to the outside via terminals 115, 125, 135, and 145, respectively.

To the DC bus 15, the first leg 11 to the fourth leg 14 are connected in parallel. The DC bus 15 is for passing DC power. The control unit 19 controls the operation states (such as an operation of transmitting power to the outside, an operation of receiving power from the outside, or the like) of the first leg 11 to the fourth leg 14 via the communication bus 16, thereby maintaining the bus voltage V₁₅ of the DC bus 15 to a predetermined value. That is, the power router 101 is connected to the outside via the first leg 11 to the fourth leg 14, but converts all of power to be outputted/inputted to/from the outside to a direct current and transmits the current to the DC bus 15. Conversion to the direct current thus allows asynchronous connections among power cells that are different in frequency, voltage, and phase.

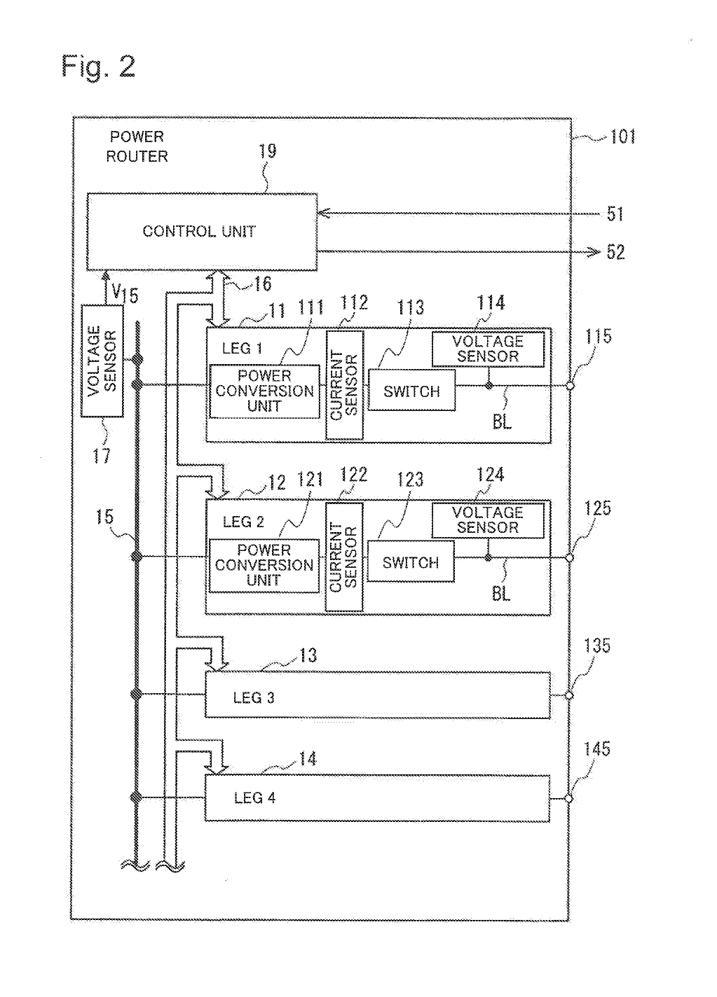

The configuration of the power router 101 will be described in detail. FIG. 2 is a block diagram of the power router 101, which illustrates an example of an internal structure of the leg. The first leg 11 to the fourth leg 14 have a similar configuration, but, for the simplification of the drawing, FIG. 2 illustrates the internal structures of the first leg 11 and the second leg 12 and does not illustrate the internal structures of the third leg 13 and the fourth leg 14.

The first leg 11 to the fourth leg 14 are connected in parallel to the DC bus 15. As described above, the first leg 11 to the fourth leg 14 have a similar configuration. In the present exemplary embodiment, an example in which the power router 101 having four legs will be described; however, this is for illustrative purposes only. A power router may have any number of legs more than one. In the present exemplary embodiment, the first leg 11 to the fourth leg 14 have a similar configuration, but two or more legs included in a power router may have a similar configuration or have different configurations. Hereinafter, the leg is called a power conversion leg.

As illustrated in FIG. 2, the first leg 11 has a power conversion unit 111, a current sensor 112, a switch 113, and a voltage sensor 114. The first leg 11 is connected to a transmission line 1200 via a connection terminal 115. The power conversion unit 111 converts AC power to DC power or converts DC power to AC power. Since DC power flows in the DC bus 15, the power conversion unit 111 converts the DC power of the DC bus 15 to AC power of predetermined frequency and voltage and passes the AC power to the outside from the connection terminal 115. Alternatively, the power conversion unit 111 converts AC power flowing in from the connection terminal 115 to DC power and passes the DC power to the DC bus 15.

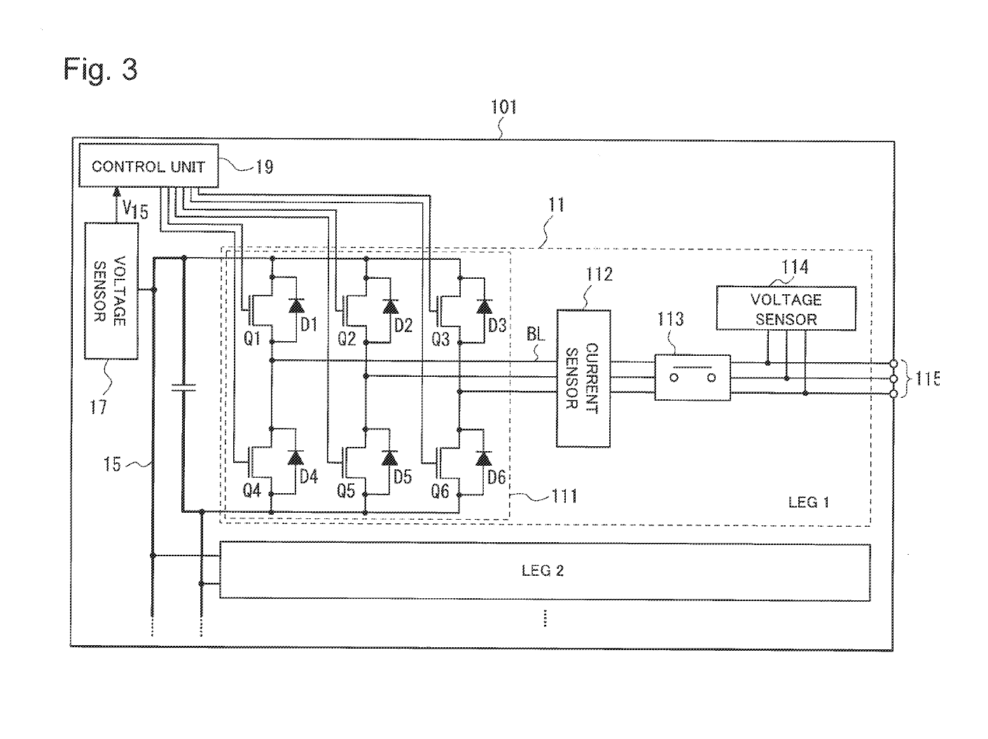

The configuration of the leg will be described in detail. FIG. 3 is a block diagram of the power router 101, which illustrates the internal structure of the leg in more detail. The first leg 11 to the fourth leg 14 have a similar configuration, but, for the simplification of the drawing, FIG. 3 illustrates the internal structure of the first leg 11 and does not illustrate the internal structure of the second leg 12, nor include the third leg 13, the fourth leg 14, or a communication bus 16.

The power converter 111 has the configuration of an inverter circuit. Concretely, as illustrated in FIG. 3, the power converter 111 has transistors Q1 to Q6 and diodes D1 to D6. One end of each of the transistors Q1 to Q3 is connected to a high-potential-side power supply line. The other ends of the transistors Q1 to Q3 are connected to one ends of the transistors Q4 to Q6, respectively. The other ends of the transistors Q4 to Q6 are connected to a low-potential-side power supply line. To the high-potential-side terminals of the transistors Q1 to Q6, the cathodes of the diodes D1 to D6 are connected, respectively. To the low-potential-side terminals of the transistors Q1 to Q6, the anodes of the diodes D1 to D6 are connected.

From the node between the transistors Q1 and Q4, the node between the transistors Q2 and Q5, and the node between the transistors Q3 and Q6, for example, by properly controlling the on/off timings of the transistors Q1 to Q6, phases of three-phase alternating current are outputted.

As described above, the power conversion unit 111 has a configuration in which six antiparallel circuits configured by transistors and diodes are three-phase-bridge connected. A wire is led from the node between the transistors Q1 and Q4, a wire is led from the node between the transistors Q2 and Q5, and a wire is led from the node between the transistors Q3 and Q6, and these wires connecting the nodes and connection terminals are called branch lines BL. Since three-phase AC is used, one leg has three branch lines BL.

Since three-phase AC is used, a three-phase inverter circuit is employed here. In some cases, a single-phase inverter circuit may be used. As the transistors Q1 to Q6, various self-commutated power conversion elements such as MOSFET (Metal-Oxide-Semiconductor Field-Effect Transistors) or IGBT (Insulated Gate Bipolar Transistor) can be used.

The switch 113 is disposed between the power conversion unit 111 and the connection terminal 115. By switching of the switch 113, the branch lines BL are switched. By the operation, the connection between the outside and the DC bus 101 are interrupted or established. The detection values of the current sensor 112 and the voltage sensor 114 are outputted to the control unit 19 via the communication bus 16.

In the above description, it is assumed that the power conversion unit uses an inverter circuit and the other side of the connection of a leg uses an alternating current. However, there is also a case where the other side of the connection of a leg uses a direct current like a storage battery (for example, the third leg 13 in FIG. 1 is connected to a storage battery 1032). The power conversion in this case is DC-DC conversion.

Accordingly, an inverter circuit and a converter circuit may be provided in parallel to the power conversion unit and the inverter circuit and the converter circuit may be properly used according to AC or DC being used by the other side of the connection. Alternatively, the power conversion unit may be provided with a leg dedicated for DC-DC conversion as a DC-DC conversion unit.

From the viewpoint of size and cost, a power router having a leg dedicated for AC-DC conversion and a leg dedicated for DC-DC conversion is more advantageous than a power router in which an inverter circuit and a converter circuit are provided in parallel in each of all of the legs.

The second leg 12 has a power conversion unit 121, a current sensor 122, a switch 123, and a voltage sensor 124. The second leg 12 is connected, for example, to a load 1031 via a connection terminal 125. The power conversion unit 121, the current sensor 122, the switch 123, and the voltage sensor 124 of the second leg 12 correspond to the power conversion unit 111, the current sensor 112, the switch 113, and the voltage sensor 114 of the first leg 11, respectively. The connection terminal 125 connected to the second leg 12 corresponds to the connection terminal 115 connected to the first leg 11. The power conversion unit 121 has a configuration in which an antiparallel circuit 121P configured with a thyristor 121T and a feedback diode 121D is three-phase-bridge connected. The thyristor 121T, the feedback diode 121D, and the antiparallel circuit 121P correspond to a thyristor 111T, a feedback diode 111D, and an antiparallel circuit 111P, respectively.

The third leg 13 has a power conversion unit 131, a current sensor 132, a switch 133, and a voltage sensor 134. The third leg 13 is connected, for example, to the storage battery 1032 via a connection terminal 135. The power conversion unit 131, the current sensor 132, the switch 133, and the voltage sensor 134 of the third leg 13 correspond to the power conversion unit 111, the current sensor 112, the switch 113, and the voltage sensor 114 of the first leg 11, respectively. The connection terminal 135 connected to the third leg 13 corresponds to the connection terminal 115 connected to the first leg 11. The power conversion unit 131 has a configuration in which an antiparallel circuit 131P configured with a thyristor 131T and a feedback diode 131D is three-phase-bridge connected. The thyristor 131T, the feedback diode 131D, and the antiparallel circuit 131P correspond to the thyristor 111T, the feedback diode 111D, and the antiparallel circuit 111P, respectively. For the simplification of the drawing, FIG. 2 does not illustrate the internal structure of the third leg 13.

The fourth leg 14 has a power conversion unit 141, a current sensor 142, a switch 143, and a voltage sensor 144. The fourth leg 14 is connected, for example, to a utility grid 1035 via a connection terminal 145. The power conversion unit 141, the current sensor 142, the switch 143, and the voltage sensor 144 of the fourth leg 14 correspond to the power conversion unit 111, the current sensor 112, the switch 113, and the voltage sensor 114 of the first leg 11, respectively. The connection terminal 145 connected to the fourth leg 14 corresponds to the connection terminal 115 connected to the first leg 11. The power conversion unit 141 has a configuration in which an antiparallel circuit 141P configured with a thyristor 141T and a feedback diode 141D is three-phase-bridge connected. The thyristor 141T, the feedback diode 141D, and the antiparallel circuit 141P correspond to the thyristor 111T, the feedback diode 111D, and the antiparallel circuit 111P, respectively. For the simplification of the drawing, FIG. 2 does not illustrate the internal structure of the fourth leg 14.

The control unit 19 receives a control instruction 51 from the external management server 1010 via a communication network 1100. The control instruction 51 includes information for instructing an operation of each leg of the power router 101. Furthermore, the control unit 19 can output information 52 indicating an operation situation of the power router 101 to the management server 1010 via the communication network 1100. In addition, the operation instruction to each leg includes, for example, designation of power transmission/power reception, designation of an operation mode, designation of power to be transmitted or received, or the like. More specifically, the control unit 19 monitors a bus voltage V15 of the DC bus 15 via a voltage sensor 17 and controls the direction of power, the frequency of AC power, or the like. That is, the control unit 19 controls switching of the transistors Q1 to Q6 and switching of the switches 113, 123, 133, and 143 via the communication bus 16.

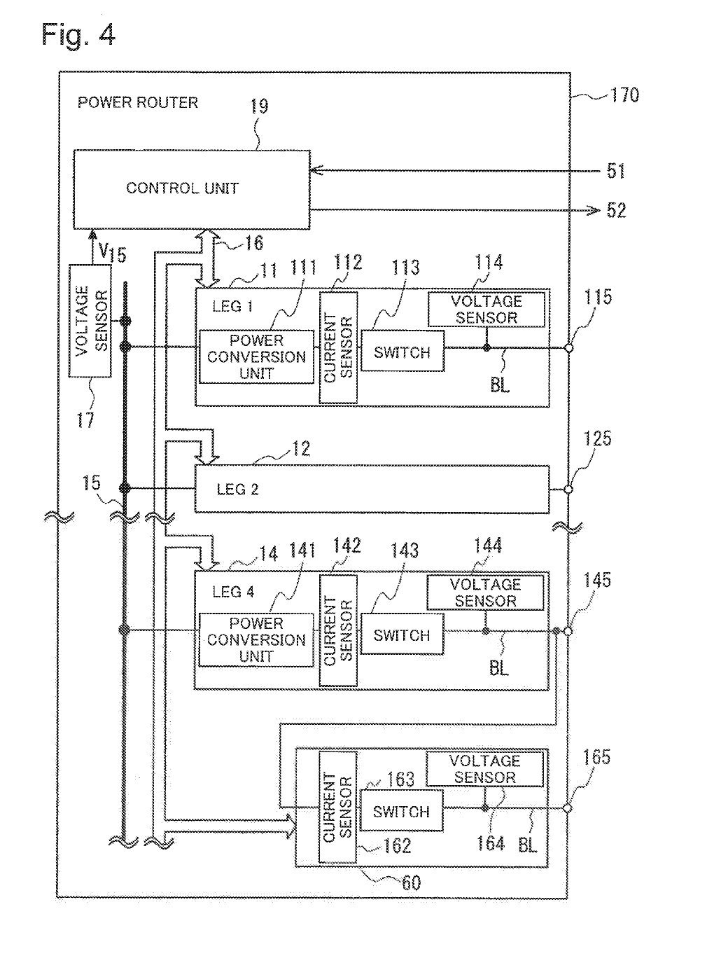

In the above description, the legs are described as having a power conversion unit; however, it is also possible to provide a leg with no power conversion unit. Hereinafter, a leg with no power conversion unit is provisionally called an AC (Alternating Current) through leg 60. FIG. 4 is a block diagram illustrating a configuration example of a power router 170 having the AC through leg 60. The power router 170 is described as having a configuration in which the AC through leg 60 is added to the power router 101. For simplification of the drawing, FIG. 4 does not illustrate the third leg 13.

The AC through leg 60 has a current sensor 162, a switch 163, and a voltage sensor 164. The AC through leg 60 is connected, for example, to another power cell via a connection terminal 165. A branch line BL of the AC through leg 60 is connected to a branch line BL of another leg having a power conversion unit via the switch 163. That is, the connection terminal 165, to which the AC through leg 60 is connected, is connected to a connection terminal to which another leg having a power conversion unit is connected. For example, FIG. 4 illustrates the case where the connection terminal 165, to which the AC through leg 60 is connected, is connected to the connection terminal 145 to which the fourth leg 14 is connected. Only the switch 163 is provided between the connection terminal 165 of the AC through leg 60 and the connection terminal 145 to which the fourth leg 14 is connected, so that the AC through leg 60 has no power conversion unit. Therefore, power is conducted without being subjected to any conversion between the connection terminal 165 to which the AC through leg 60 is connected and the connection terminal 145 to which the fourth leg 14 is connected. Therefore, a leg having no power conversion unit is called an AC through leg.

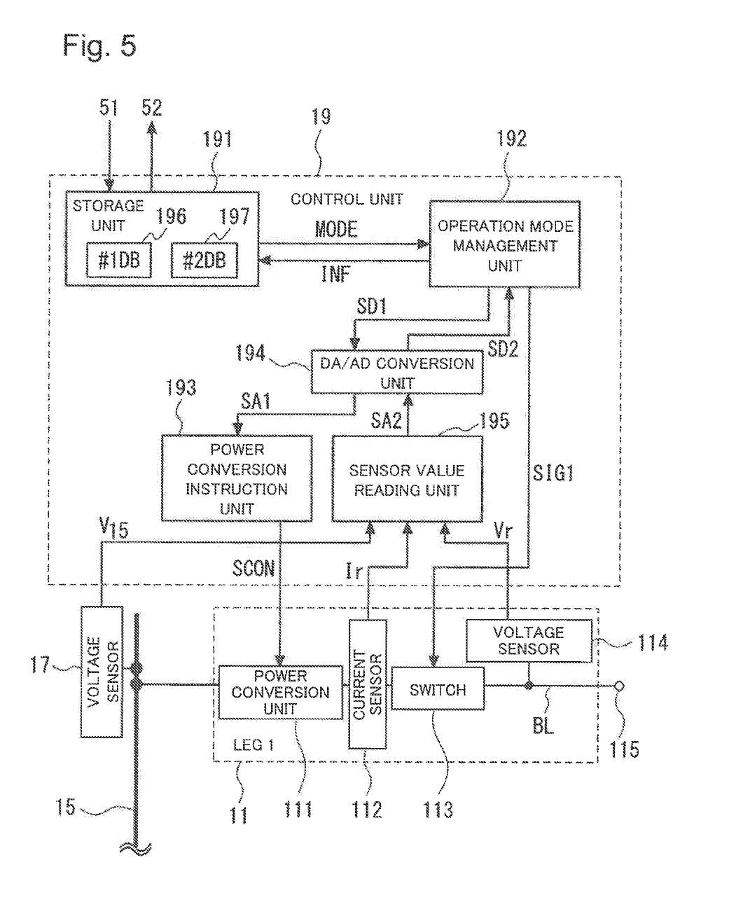

FIG. 5 is a block diagram schematically illustrating a relation between a configuration of the control unit 19 and the leg. FIG. 5 illustrates the case where the control unit 19 controls the first leg 11. The control unit 19 has a storage unit 191, an operation mode management unit 192, a power conversion instruction unit 193, a DA/AD conversion unit 194, and a sensor value reading unit 195.

The storage unit 191 holds the control instruction 51 from the management server 1010 as a control instruction database 196 (a first database indicated by #1DB in the drawing). In addition to the control instruction database 196, the storage unit 191 holds a leg identification information database 197 (a second database indicated by #2DB in the drawing) for identifying each of the first leg 11 to the fourth leg 14. The storage unit 191 can be realized, for example, by various storage units such as a flash memory. The leg identification information database 197 is information, such as an IP address, URL, and URI, assigned in order to specify each of the first leg 11 to the fourth leg 14. Furthermore, on the basis of information INF from the operation mode management unit 192, the storage unit 191 holds the information 52 indicating the operation situation of the power router 101 and outputs the information 52 indicating the operation situation of the power router 101 to the outside as necessary.

The operation mode management unit 192 is configured, for example, by CPU. The operation mode management unit 192 reads operation mode designation information MODE which is included in the control instruction database 196 and designates an operation mode (which will be described later) of a leg (the first leg 11) to be stopped. Furthermore, the operation mode management unit 192 reads information (for example, an IP address) corresponding to the leg (the first leg 11) to be stopped by referring to the leg identification information database 197 of the storage unit 191. By the operation, the operation mode management unit 192 can output a start instruction for the leg (the first leg 11) to be stopped. The operation mode management unit 192 outputs a waveform instruction signal SD1 which is a digital signal. Furthermore, the operation mode management unit outputs a switching control signal SIG1 to a switch (for example, the switch 113) of the leg to be stopped.

The waveform instruction signal SD1 is subjected to digital-to-analog conversion in the DA/AD conversion unit 194 and is outputted to the power conversion instruction unit 193 as a waveform instruction signal SA1 which is an analog signal. The power conversion instruction unit 193 outputs a control signal SCON to a power conversion unit (for example, the power conversion unit 111) in response to the waveform instruction signal SA1.

The sensor value reading unit 195 reads a value of the bus voltage V15 detected by the voltage sensor 17, a detection value Ir of the current sensor 112 of the leg (the first leg 11) to be stopped, and a detection value Vr of the voltage sensor 114. The sensor value reading unit 195 outputs a reading result as a reading signal SA2 which is an analog signal. The reading signal SA2 is subjected to analog-to-digital conversion in the DA/AD conversion unit 194 and is outputted to the operation mode management unit 192 as a reading signal SD2 which is a digital signal. On the basis of the reading signal SD2 which is a digital signal, the operation mode management unit 192 outputs the information INF indicating the operation situation of a leg to the storage unit 191.

Next, an operation mode of the legs of the power router 101 will be described. In the present exemplary embodiment, the operation mode designation of each leg is included in the control instruction 51.

Firstly, the operation mode will be described. It has been already described that the first leg 11 to the fourth leg 14 have the power conversion units 111, 121, 131, and 141, respectively, and the switching operation of the transistors in the power conversion units is controlled by the control unit 19.

The power router 101 is a node in the power network system 1000 and has an important role of connecting the utility grid 1035, the load 1031, a distributed power supply, a power cell, or the like. The connection terminals 115, 125, 135, and 145 of the first leg 11 to the fourth leg 14 are connected to the utility grid 1035, the load 1031, the distributed power supply, and power routers of other power cells, respectively. The inventors have noticed that since the roles of the first leg 11 to the fourth leg 14 vary according to the other side of connections, if the first leg 11 to the fourth leg 14 do not perform proper operations according to the roles, the power routers do not work. By the inventors, the structures of legs are the same but the way of operating the legs is changed according to the other side of the connection.

The way of operating the legs is called an “operation mode”.

By the inventors, three kinds are prepared as operation modes of a leg, and the mode is switched according to the other side of the connection.

As the operation modes of the leg, there are a master mode, a stand-alone mode, and a designated power transmission/reception mode.

Hereinafter, the modes will be described in order.

(Master Mode)

The master mode (Mastar) is an operation mode in the case where a leg is connected to a stable power supply source such as a grid, and an operation mode for maintaining the voltage of the DC bus 15. In the master mode, a leg is connected to a stable AC power supply source and an AC bus voltage is maintained, or a leg is connected to a stable DC power supply source and a DC bus voltage is maintained. FIG. 1 illustrates an example that the connection terminal 145 of the fourth leg 14 is connected to the utility grid 1035. In the case of FIG. 1, the fourth leg 14 is controlled so as to operate in the master mode and plays the role of maintaining the bus voltage V15 of the DC bus 15. Since the other first leg 11 to third leg 13, are connected to the DC bus 15, power may flow in from the first leg 11 to the third leg 13 to the DC bus 15, or power may flow out to the first leg 11 to the third leg 13. In the case where the bus voltage V15 of the DC bus 15 drops from a rated voltage due to the outflow of power from the DC bus 15, the fourth leg 14 in the master mode makes up for the amount of power which has become insufficient due to the outflow, with power from the other side of the connection (in this case, the utility grid 1035). In the case where the bus voltage V15 of the DC bus 15 rises from the rated voltage due to inflow of power to the DC bus 15, the amount of power which has become excessive due to the inflow is passed on to the other side of the connection (in this case, the utility grid 1035). By such an operation, the fourth leg 14 in the master mode maintains the bus voltage V15 of the DC bus 15.

Consequently, in one power router, at least one leg has to be operated in the master mode. Otherwise, the bus voltage V15 of the DC bus 15 is not maintained constant. Although two or more legs may be operated in the master mode in one power router, it is advantageous that the number of legs in the master mode in one power router is one.

A leg in the master mode may be connected to, other than a utility grid, for example, a distributed power supply (including a storage battery) having a self-commutated inverter. A distributed power supply having an externally commutated inverter and a leg in the master mode cannot be connected to each other.

In the following description, the leg operated in the master mode may also be called a “master leg”.

Operation control of the master leg will be described.

The start-up of the master leg is as follows.

First, the switch 143 is set to an open (broken) state. In this state, the connection terminal 145 is connected to the other side of a connection. In this case, the other side of the connection is the utility grid 1035. The voltage sensor 144 measures the voltage of a grid as a connection destination, and obtains the amplitude, frequency, and phase of the voltage of the grid by using PLL (Phase-Locked-Loop) or the like. After that, the output of the power conversion unit 141 is adjusted such that the voltage of the obtained amplitude, frequency, and phase is outputted from the power conversion unit 141. That is, the on/off pattern of the transistors Q1 to Q6 is decided. When the output becomes stable, the switch 143 is turned on, the power conversion unit 141 and the utility grid 1035 are connected to each other. At this time point, the output of the power conversion unit 141 and the voltage of the utility grid 1035 are synchronized with each other, so that no current flows.

Operation control at the time of operating the master leg will be described.

The voltage sensor 17 measures the bus voltage V15 of the DC bus 15. When the bus voltage V15 of the DC bus 15 exceeds a predetermined rated bus voltage, the power conversion unit 141 is controlled so that power transmission is performed from the master leg (the fourth leg 14) toward the grid (at least one of the amplitude and phase of the voltage outputted from the power conversion unit 141 is adjusted, so that power transmission is performed from the DC bus 15 toward the utility grid 1035 via the master leg (the fourth leg 14)). The rated voltage of the DC bus 15 is predetermined by a setting.

On the other hand, when the bus voltage V15 of the DC bus 15 is lower than the predetermined rated bus voltage, the power conversion unit 141 is controlled so that the master leg (the fourth leg 14) can receive power from the utility grid 1035 (at least one of the amplitude and phase of the voltage outputted from the power conversion unit 141 is adjusted, so that power transmission is performed from the utility grid 1035 to the DC bus 15 via the master leg (the fourth leg 14). It will be understood that by performing such operation of the master leg, the bus voltage V15 of the DC bus 15 can maintain the predetermined rated voltage.

(Stand-Alone Mode)

The stand-alone mode (Stand Alone) is an operation mode of generating a voltage having amplitude and frequency designated by the management server 1010 and transmitting/receiving power to/from the other side of a connection.

For example, it is an operation mode of supplying power to a power consumption side such as the load 1031 or an operation mode of receiving power transmitted from the other side of the connection. The stand-alone mode is an operation mode of creating designated voltage and frequency and supplying the created voltage and frequency to the other side of the connection.

FIG. 1 illustrates an example that the connection terminal 125 of the second leg 12 is connected to the load 1031. The second leg 12 is controlled so as to be operated in the stand-alone mode and supplies power to the load 1031.

When a leg is connected to another power router, there is a case where the leg is operated in the stand-alone mode as a mode of transmitting an amount of power required by the other power router.

When a leg is connected to another power router, there is a case where the leg is operated in the stand-alone mode as a mode of receiving power transmitted from the other power router.

Although not illustrated in the drawing, also in the case where the second leg is connected to a power generating facility instead of the load 1031, the second leg can be operated in the stand-alone mode. In this case, the power generating facility is provided with an externally commutated inverter.

An operation mode in the case of interconnecting power routers will be described later.

A leg operated in the stand-alone mode will be called a “stand-alone leg”. In one power router, there may be a plurality of stand-alone legs.

Operation control of a stand-alone leg will be described.

First, the switch 123 is opened (broken). The connection terminal 125 is connected to the load 1031. The amplitude and frequency of power (a voltage) to be supplied to the load 1031 are instructed from the management server 1010 to the power router 101. The control unit 19 performs control so that the power (the voltage) of the instructed amplitude and frequency is outputted from the power conversion unit 121 toward the load 1031 (that is, the control unit 19 decides the on/off pattern of the transistors Q1 to Q6). When the output becomes stable, the control unit 19 connects the power conversion unit 121 to the load 1030 by turning on the switch 123. After that, when the power is consumed by the load 1031, the power of the consumed amount flows from the stand-alone leg (the second leg 12) to the load 1301.

(Designated-Power Transmission/Reception Mode)

A designated-power transmission/reception mode (Grid Connect) is an operation mode for transmitting/receiving power of an amount decided by designation. In the designated-power transmission/reception mode, designated active power is transmitted/received between connection destinations. Designated reactive power is generated. That is, there are a case of transmitting designated power to the other side of a connection and a case of receiving designated power from the other side of a connection.

When a leg is connected to a leg of another power router, power of a decided amount is interchanged from one side to the other side.

The third leg 13 is connected to the storage battery 1032.

In such a case, the power of the decided amount is transmitted toward the storage battery 1032, so that the storage battery 1032 is charged.

Alternatively, a distributed power supply (including a storage battery) having a self-commutated inverter and a designated-power transmission/reception leg may be connected to each other. However, a distributed power supply having an externally commutated inverter and a designated-power transmission/reception leg cannot be connected to each other.

A leg operated in the designated-power transmission/reception mode will be called a “designated-power transmission/reception leg”. In one power router, a plurality of designated-power transmission/reception legs may exist.

Operation control of a designated-power transmission/reception leg will be described. Since the control at the time of startup is basically the same as that of the master leg, a description thereof will not be repeated.

Operation control at the time of operating a designated-power transmission/reception leg will be described. In FIG. 1, the first leg 11 transmits/receives power designated power to/from a first leg 21 of a power router 102 operating in the stand-alone mode via the transmission line 1200. In the first leg 11 of the power router 101, the voltage of a grid of the other side of a connection is measured by the voltage sensor 114 and the frequency and phase of the voltage of the other side of the connection are obtained using PLL (Phase-Locked-Loop) or the like. On the basis of an active power value and a reactive power value designated by the management server 1010 and the frequency and phase of the voltage of the other side of the connection, the power conversion unit 111 obtains a target value of a current which is inputted/outputted. The current sensor 112 measures a present current value. The power conversion unit 111 is adjusted so that a current corresponding to the difference between the target value and the present value is additionally outputted (by adjusting at least one of the amplitude and phase of the voltage outputted from the power conversion unit 111, desired power flows between the designated-power transmission/reception leg and the other side of the connection).

As described above, it will be understood that the first leg 11 to the fourth leg 14 having the same configuration can play the roles of three patterns according to the way of the operation control.

The power router 101 can operate each leg in the above-described three operation modes by referring to the designation information of operation modes included in the control instruction 51. The power router 101 can thus appropriately operate each leg in accordance with the role of each leg.

Next, connection restrictions between power routers will be described. Since the operations of legs vary according to the operation modes, restriction naturally occurs between the selection of the other side of a connection and the selection of an operation mode. That is, when the other side of the connection is decided, an operation mode which can be selected is decided. Conversely, when an operation mode is decided, the other side of the connection which can be selected is decided (when the other side of the connection changes, it becomes necessary to change the operation mode of the leg accordingly).

Patterns of possible connection combinations will be described below.

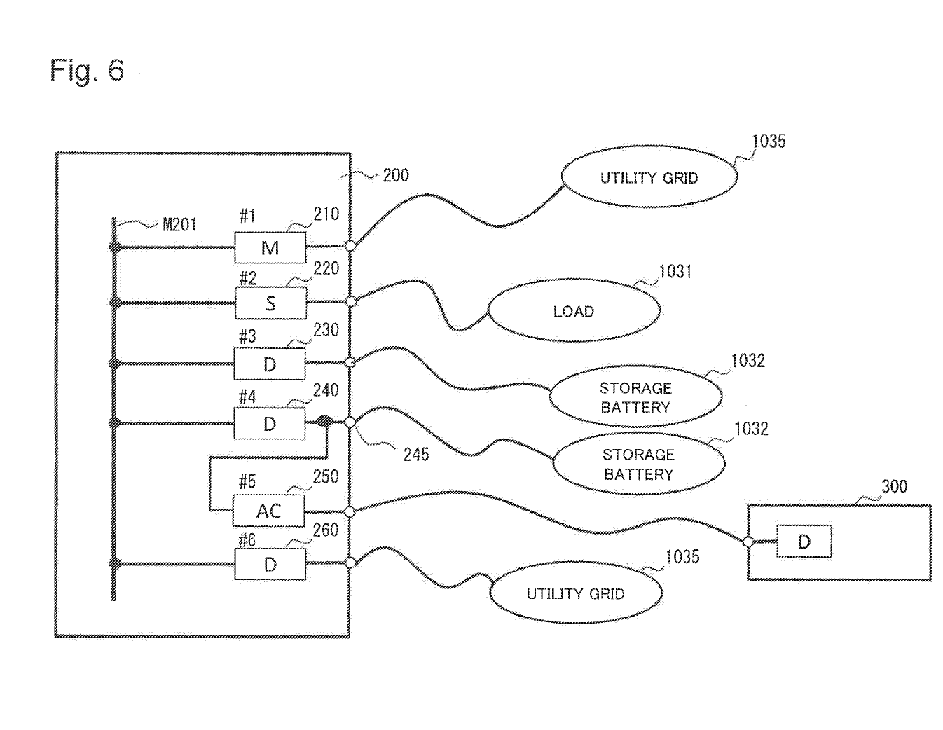

In the following description, signage in the drawings will be simplified as illustrated in FIG. 6.

That is, the master leg is expressed by “M”.

The stand-alone leg is expressed by “5”.

The designated-power transmission/reception legs are expressed by “D”.

The AC through leg is expressed by “AC”.

By assigning numbers like “#1” at the shoulder of a leg as necessary, the legs may be distinguished.

In FIG. 6 to FIG. 12, systematic reference numerals are assigned. However, the same reference numerals are not always designated to the same elements among the drawings.

For example, reference numeral 200 in FIG. 6 and reference numeral 200 in FIG. 4A do not refer to the same element.

Connection combinations illustrated in FIG. 6 are possible connections. A first leg 210 is connected as a master leg to the utility grid 1035 as also already described. A second leg 220 is connected as a stand-alone leg to the load 1031 as also already described. A third leg 230 and a fourth leg 240 are connected as designated-power transmission/reception legs to the storage battery 1032 as also already described.

A fifth leg 250 is an AC through leg. The AC through leg 250 is connected to a designated-power transmission/reception leg of another power router 300 and is also connected to the storage battery 1032 via a connection terminal 245 of the fourth leg 240. Since the AC through leg 250 does not have a power conversion unit, the connection relation is equivalent to that of the designated-power transmission/reception leg of another power router 300 being directly connected to the storage battery 1032. It will be understood that such a connection is allowed.

A sixth leg 260 is connected to the utility grid 1035 as a designated-power transmission/reception leg. When it is assumed that determined power is received from the utility grid 1035 via the sixth leg 260, it will be understood that such a connection is allowed. As for the relation with the first leg 210, which is the master leg, if the power received by the sixth leg 260 is insufficient to maintain a rated voltage of a DC bus M201, the master leg 210 receives necessary power from the utility grid 1035. Conversely, when the power received by the sixth leg 260 exceeds an amount necessary to maintain the rated voltage of the DC bus M201, the master leg 210 passes excessive power to the utility grid 1035.

Next, the case of connecting power routers will be described. Connection of power routers means connection of a leg of one power router and a leg of another power router. In the case of connecting legs, there is a restriction in an operation mode for the combination.

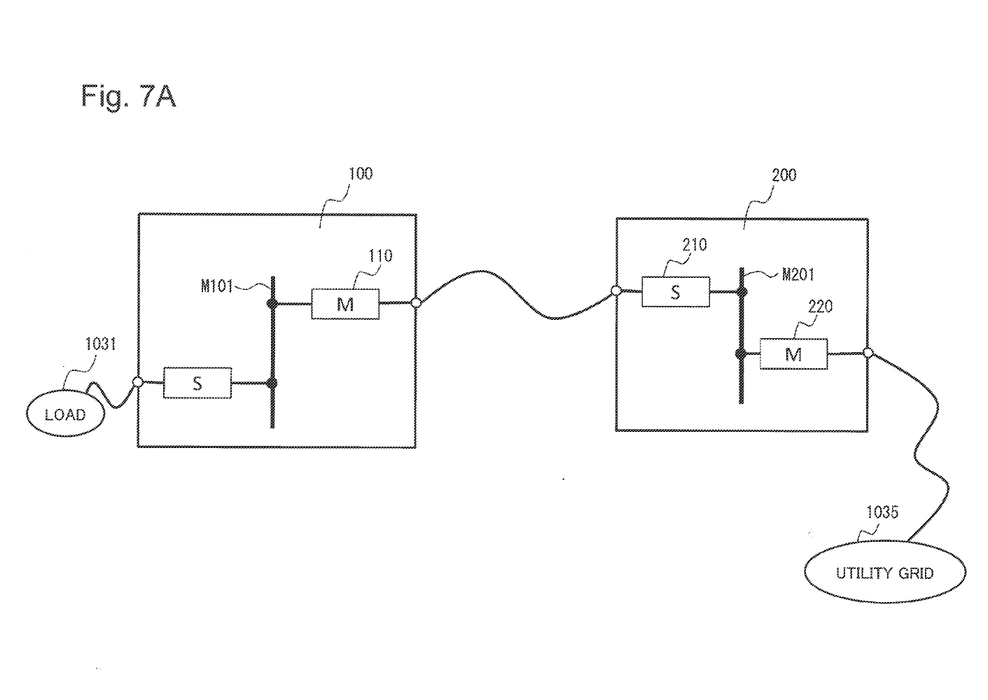

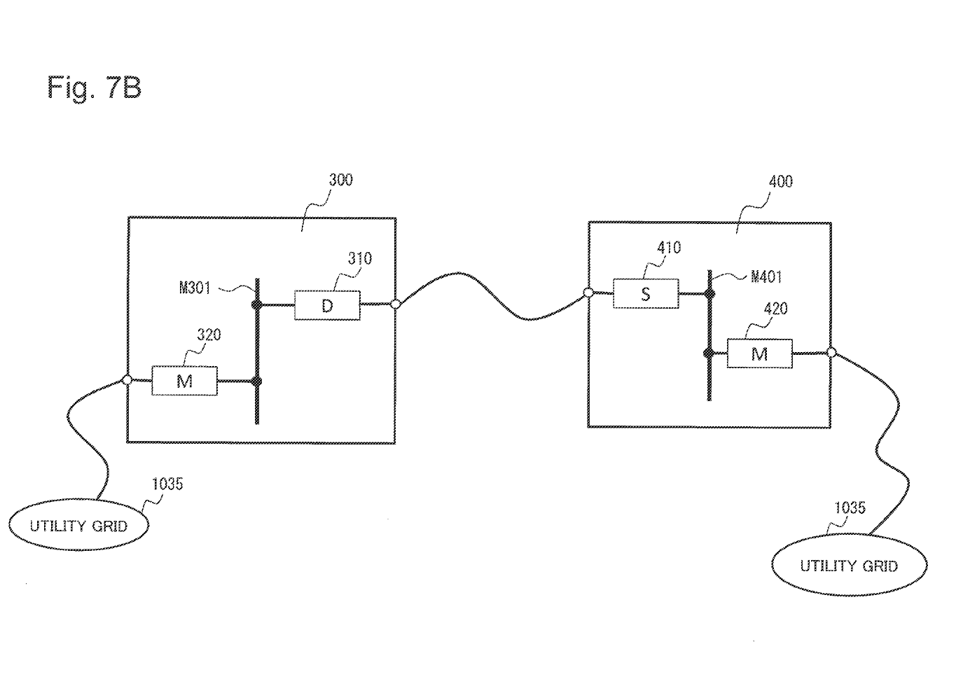

Both of combinations of connections illustrated in FIGS. 7A and 7B are examples of possible combinations. In FIG. 7A, the master leg 110 of the first power router 100 and the stand-alone leg 210 of the second power router 200 are connected to each other. Although it will not be specifically described, the master leg 220 of the second power router 200 is connected to the utility grid 1035, thereby maintaining the voltage of the DC bus M201 of the second power router 200 at the rated voltage.

In FIG. 7A, when power is supplied from the first power router 100 to the load 1031, the voltage of the DC bus M101 drops. The master leg 110 obtains power from the other side of a connection so as to maintain the voltage of the DC bus M101. In other words, the master leg 110 draws power of an insufficient amount from the stand-alone leg 210 of the second power router 200. The stand-alone leg 210 of the second power router 200 transmits power of the amount required from the other side of the connection (in this case, the master leg 110). In the DC bus M201 of the second power router 200, although the voltage drops only by the power transmission amount from the stand-alone leg 210, it is compensated from the utility grid 1035 by the master leg 220. In such a manner, the first power router 100 can obtain the power of a necessary amount from the second power router 200.

As described above, even when the master leg 110 of the first power router 100 and the stand-alone leg 210 of the second power router 200 are connected, since the role of the master leg 110 and that of the stand-alone leg 210 fit together, no inconvenience occurs in the operations. It is therefore understood that a master leg and a stand-alone leg may be connected as illustrated in FIG. 7A.

In FIG. 7B, a designated-power transmission/reception leg 310 of the third power router 300 and a stand-alone leg 410 of a fourth power router 400 are connected to each other. Although it will not be specifically described, a master leg 320 of the third power router 300 and a master leg 420 of the fourth power router 400 are connected to the utility grid 1035, so that DC buses M301 and M401 of the third and fourth power routers 300 and 400 maintain the rated voltage.

It is assumed that, by an instruction from the management server 1010, the designated-power transmission/reception leg 310 of the third power router 300 is instructed to receive designated power. The designated-power transmission/reception leg 310 draws the designated power from the stand-alone leg 410 of the fourth power router 400. The stand-alone leg 410 of the fourth power router 400 transmits power of an amount required by the other side of a connection (in this case, the designated-power transmission/reception leg 310). In the DC bus M401 of the fourth power router 400, although the voltage drops only by the amount of power transmitted from the stand-alone leg 410, it is compensated from the utility grid 1035 by the master leg 420.

As described above, even when the designated-power transmission/reception leg 310 of the third power router 300 and the stand-alone leg 410 of the fourth power router 400 are connected, since the role of the designated-power transmission/reception leg 310 and that of the stand-alone leg 410 fit together, no inconvenience occurs in the operations. It is therefore understood that a designated-power transmission/reception leg and a stand-alone leg may be connected as illustrated in FIG. 7B.

Although the case where the third power router 300 receives power from the fourth power router 400 has been described, it will be understood that there is similarly no inconvenience also in the case where power is conversely given from the third power router 300 to the fourth power router 400.

In such a manner, designated power can be given between the third and fourth power routers 300 and 400.

In the case of directly connecting legs having power converters, only two patterns illustrated in FIGS. 7A and 7B are allowed. In other words, only the pattern of connecting a master leg and a stand-alone leg and the pattern of connecting a designated-power transmission/reception leg and a stand-alone leg are allowed.

Next, combinations of legs which cannot be connected will be described.

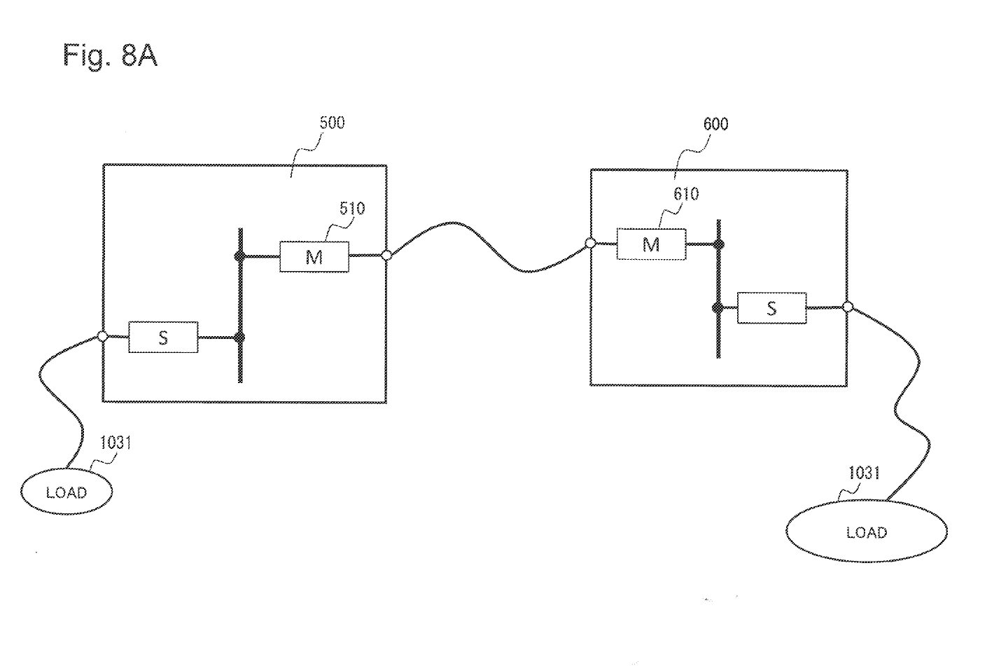

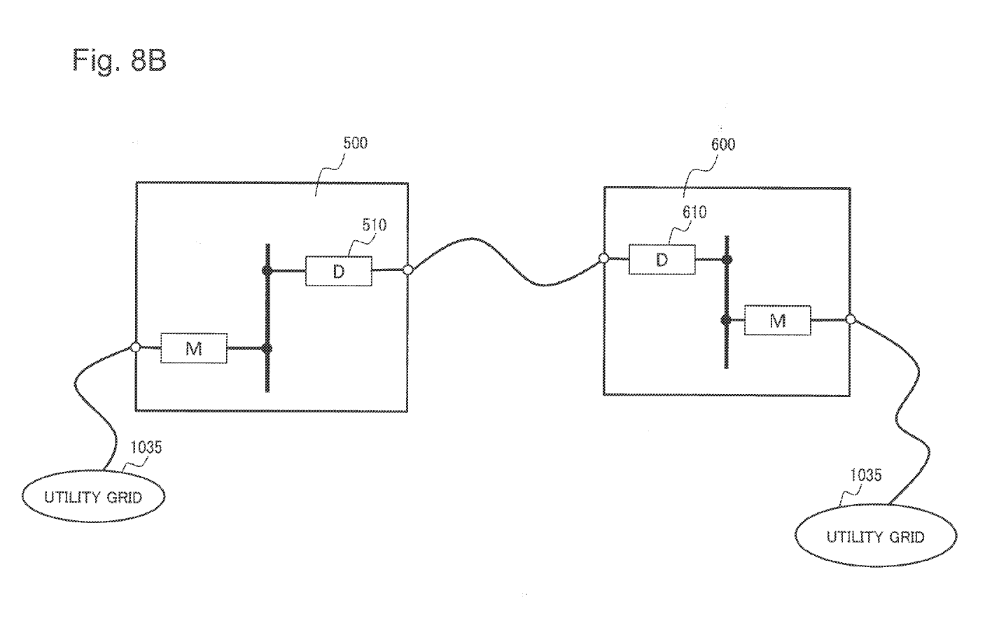

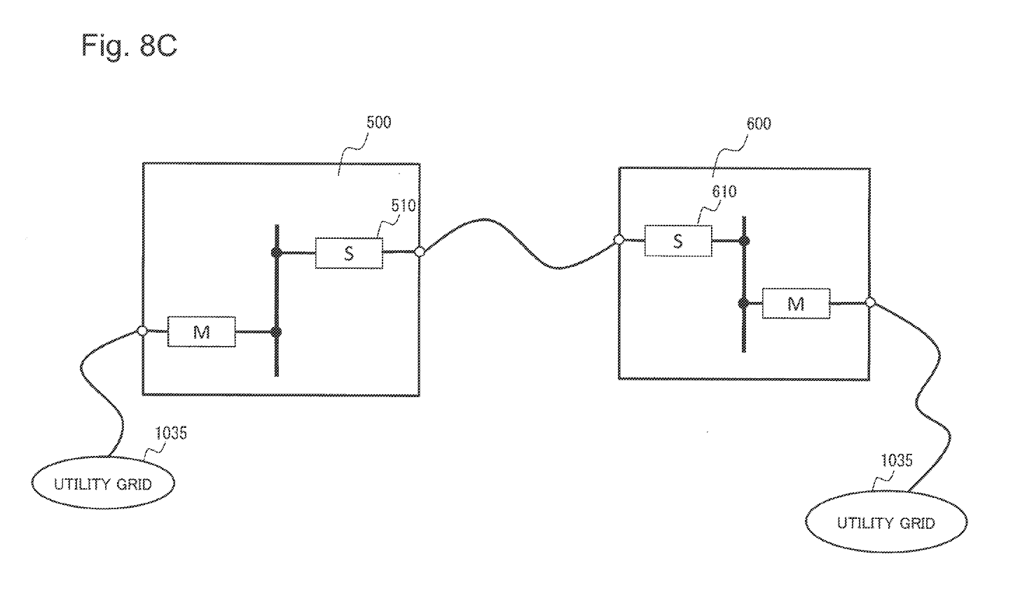

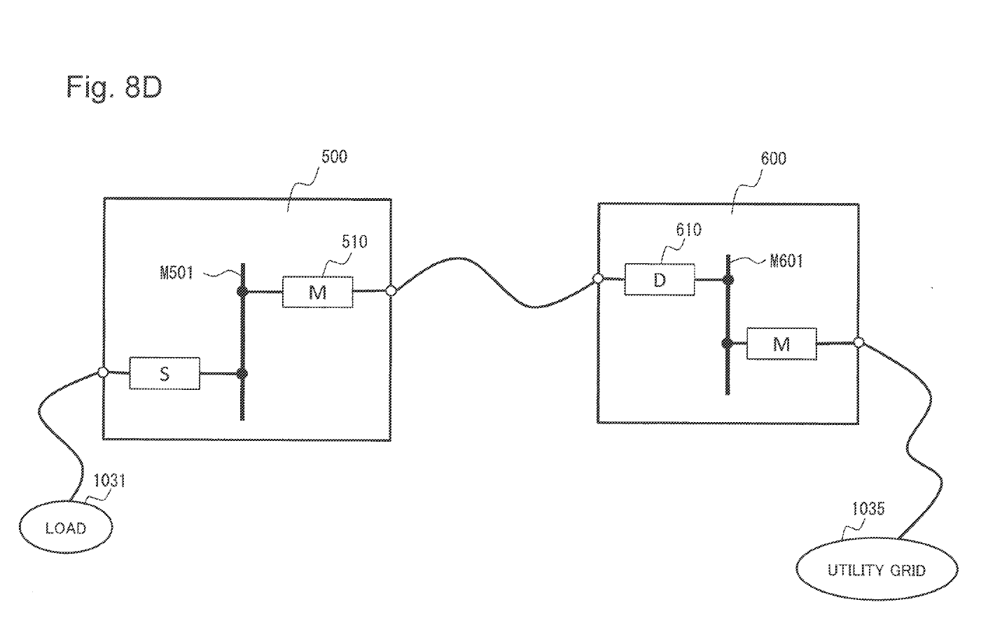

FIGS. 8A to 8D illustrate patterns of legs which cannot be connected to each other.

As will be seen from FIGS. 8A, 8B, and 8C, legs in the same operation mode cannot be connected to each other.

For example, in the case of FIG. 8A, master legs 510 and 610 are connected to each other.

As described above in relation to the operation, first, a master leg performs the process of generating power synchronized with the voltage, frequency, and phase of the other side of the connection.

In the case where the other side of the connection is also a master leg, the master legs try to synchronize with the voltage and frequency of the other side. However, since the master legs do not autonomously establish the voltage and frequency, such a synchronizing process cannot succeed.

Therefore, the master legs cannot be connected to each other.

There is also another reason.

A master leg has to draw power from the other side of the connection in order to maintain the voltage of the DC bus (or has to pass excessive power to the other side of the connection in order to maintain the voltage of the DC bus). When the master legs are connected to each other, they cannot mutually satisfy requirements of the other sides of connection (if master legs are connected to each other, neither of the power routers cannot maintain the voltages of respective DC buses. Therefore, problems such as black-out may occur in each of the power cells). As described above, since the roles of the master legs conflict (do not fit together), the master legs cannot be connected to each other.

FIG. 8B illustrates designated-power transmission/reception legs being connected to each other, but it will be understood that this is not successful, either.

Like the above master legs and as described above in relation to the operation, first, a designated-power transmission/reception leg performs the process of generating power synchronized with the voltage, frequency, and phase of the other side of a connection.

In the case where the other side of the connection is also a designated-power transmission/reception leg, the legs try to synchronize with the voltage and frequency of the other side. However, since the designated-power transmission/reception legs do not autonomously establish a voltage and frequency, such a synchronizing process cannot succeed.

Therefore, the designated-power transmission/reception legs cannot be connected to each other.

There is also another reason.

Even if designated transmission power to be transmitted from one designated-power transmission/reception leg 510 and designated reception power to be received by the other designated-power transmission/reception leg 610 are matched, such the designated-power transmission/reception legs cannot be connected to each other. For example, it is assumed that the one designated-power transmission/reception leg 510 adjusts a power conversion unit to transmit the designated transmission power (for example, the designated-power transmission/reception leg 510 allows an output voltage to be higher than the output voltage of the other side of a connection by a predetermined value). On the other hand, the other designated-power transmission/reception leg 610 adjusts a power conversion unit to receive the designated reception power (for example, the other designated-power transmission/reception leg 610 allows the output voltage to be lower than that of the other side of the connection by a predetermined value). When such adjusting operations are performed simultaneously in both of the designated-power transmission/reception legs 510 and 610, it will be understood that both of the legs become out of control.

FIG. 8C illustrates stand-alone legs being connected to each other. However, such a connection is not allowed.

A stand-alone leg generates a voltage and a frequency by itself.

If any of the voltages, frequencies, and phases generated by two stand-alone legs differ even slightly in a state where the stand-alone legs are connected to each other, an unintended power flows between the two stand-alone legs.

Since it is difficult to keep a state in which the voltages, frequencies, and phases generated by two stand-alone legs are perfectly matched, it is not allowed to connect stand-alone legs to each other.

FIG. 8D illustrates a master leg and a designated-power transmission/reception leg being connected to each other.

From the above description, it will be understood that this connection does not work, either. Even when the master leg 510 tries to transmit/receive power to/from the other side of a connection so as to maintain the voltage of a DC bus M501, the designated-power transmission/reception leg 610 does not transmit/receive power in response to a request of the master leg 510. Therefore, the master leg 510 cannot maintain the voltage of the DC bus M501. Even when the designated-power transmission/reception leg 610 tries to transmit/receive designated power to/from the other side (510) of a connection, the master leg 510 does not transmit/receive the power in response to a request of the designated-power transmission/reception leg 610. Therefore, the designated-power transmission/reception leg 610 cannot transmit/receive the designated power to/from the other side of the connection (in this case, the master leg 510).

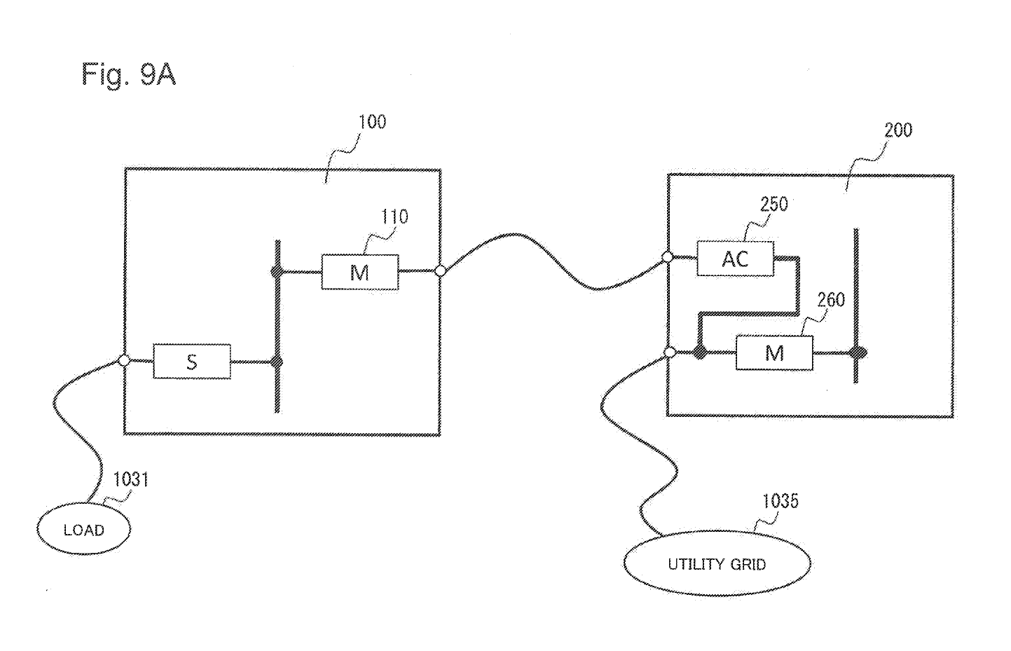

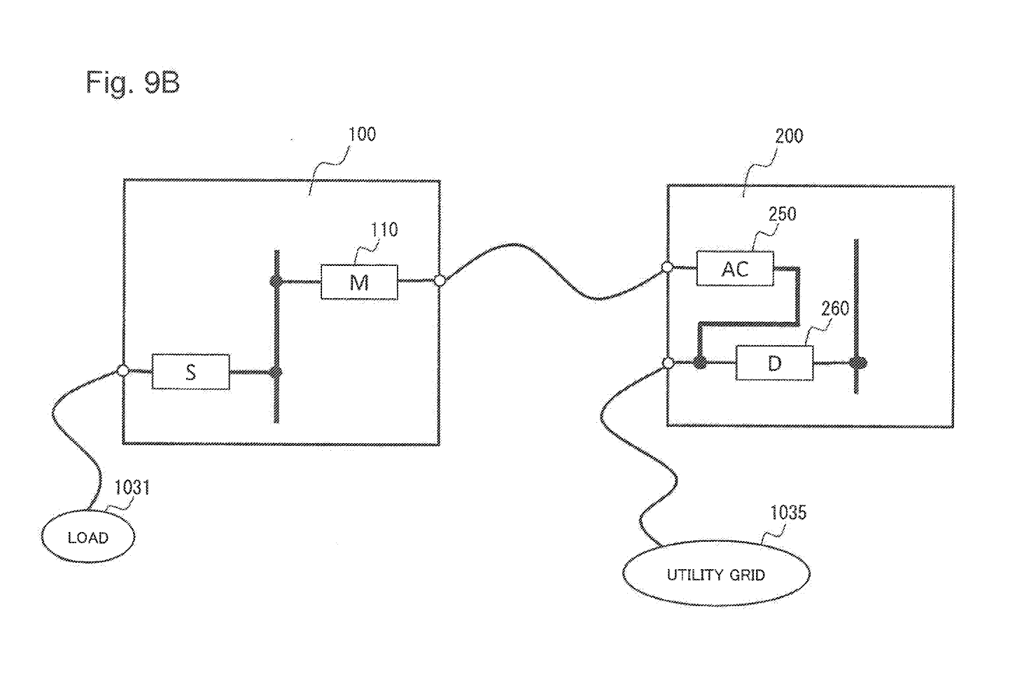

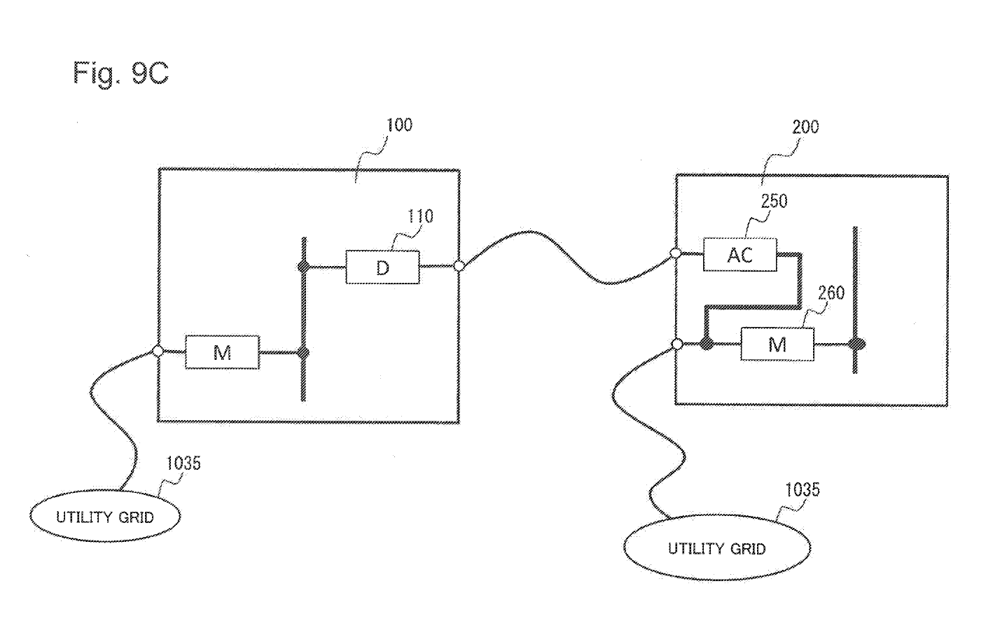

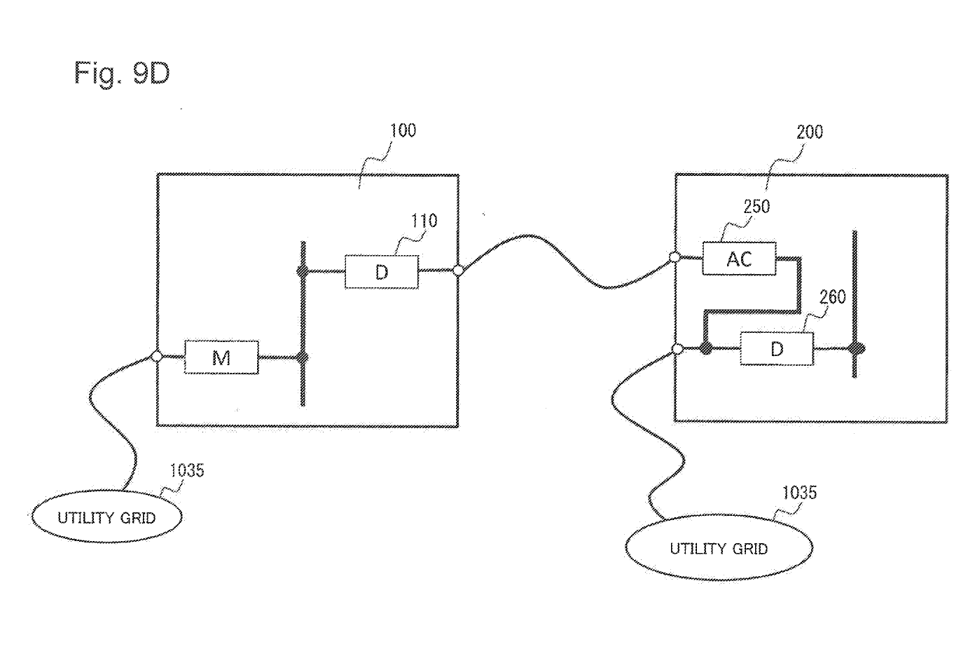

Although the cases in which legs having a power conversion unit are connected with each other have been considered, patterns illustrated in FIGS. 9A to 9D are also possible when an AC through leg is taken into consideration. Since an AC through leg has no power conversion unit, it is simply a bypass. Therefore, as illustrated in FIGS. 9A and 9B, a connection of the master leg 110 of the first power router 100 to the utility grid 1035 via the AC through leg 250 of the second power router 200 is substantially the same as a direct connection of the master leg 110 to the utility grid 1035. Similarly, as illustrated in FIGS. 9C and 9D, a connection of the designated-power transmission/reception leg 110 of the first power router 100 to the utility grid 1035 via the AC through leg 250 of the second power router 200 is substantially the same as a direct connection of the designated-power transmission/reception leg 110 to the utility grid 1035.

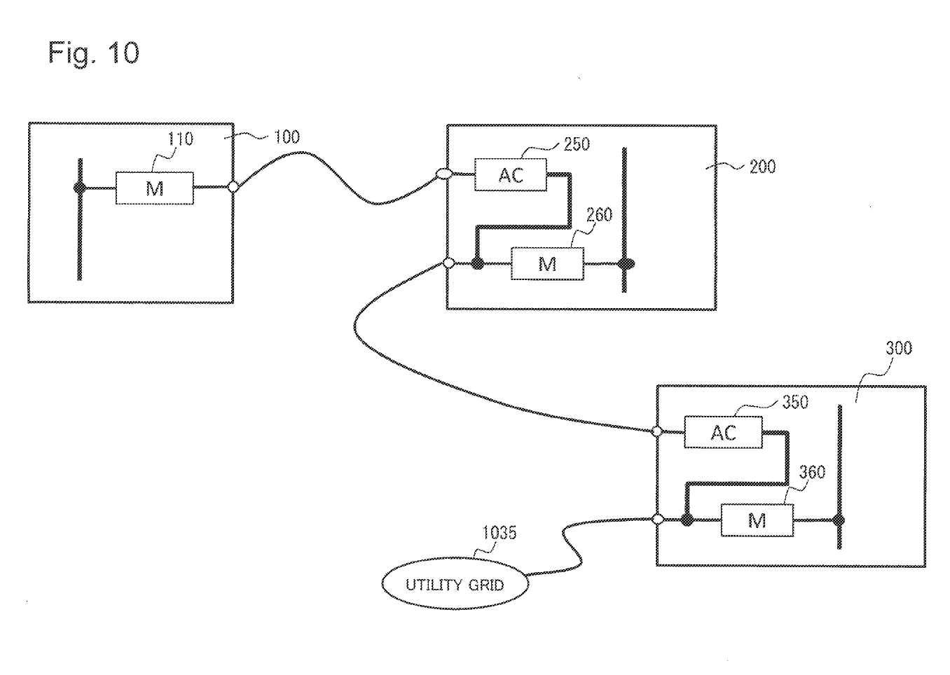

Even so, when an AC through leg is provided, there are the following advantages. For example, a case is considered in which, as illustrated in FIG. 10, the distance from the first power router 100 to the utility grid 1035 is very long and the first power router 100 has to be connected to the utility grid 1035 via some power routers 200 and 300. If there is no AC through leg, the first power router 100 has to be connected via one or more stand-alone legs as illustrated in FIG. 7A. When the first power router 100 is connected via a leg having a power converter, output is subjected to conversion from AC power to DC power and conversion from DC power to AC power. In the power conversion, although only a few percent, energy loss occurs. Therefore, a plurality of times of power conversion required only for a connection to the utility grid is insufficient. Therefore, it is meaningful to provide a power router with an AC through leg having no power conversion unit.

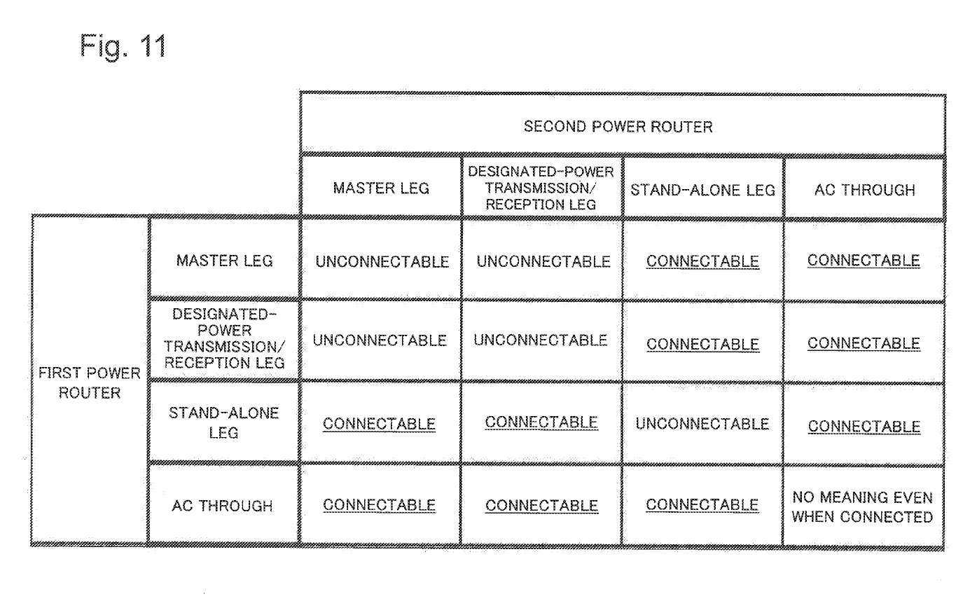

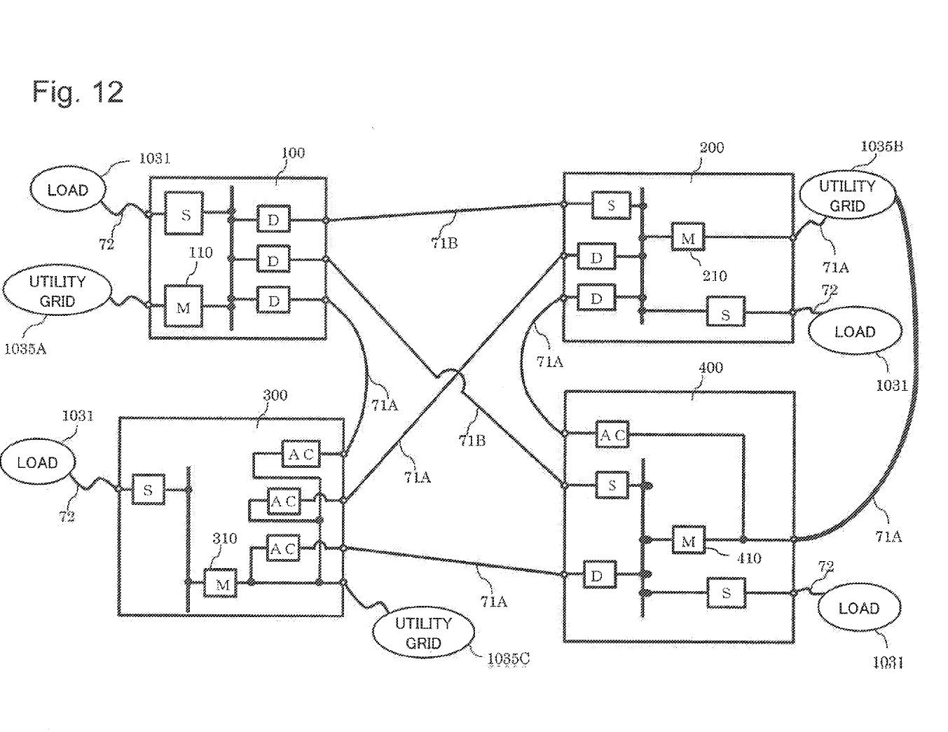

FIG. 11 illustrates the summary of the above description. FIG. 12 is a diagram illustrating an example of the case of connecting the four power routers 100, 200, 300, and 400 to one another. In FIG. 12, by reference numeral “71A” is designated power transmission lines as a part of the utility grid, and by reference numeral “71B” is designated power transmission lines detached from the utility grid. When a connection line connecting a power router and a load (or a distributed power supply) is called a power distribution line 72, the power distribution lines 72 are detached from the utility grid 1035. That is, the power distribution line 72 connecting the power router to the load (or the distributed power supply) is not connected to the utility grid 1035. Reference numerals 1035A to 1035C indicate utility grids. Since all of the connection relations are described above, each connection destinations will not be described in detail. However, it will be understood that all the connection relations are allowable connection relations.

Next, referring once again to FIG. 1, the power router 102 will be described. The power router 102 has a configuration similar to that of the power router 101. The power router 102 has, roughly, the DC bus 15, the communication bus 16, a first leg 21, a second leg 22, a third leg 23, a fourth leg 24, and the control unit 19. In the drawing, because of limited space, the first leg to the fourth leg are indicated as leg 1 to leg 4, respectively. The first leg 21, the second leg 22, the third leg 23, and the fourth leg 24 have configurations similar to those of the first leg 11, the second leg 12, the third leg 13, and the fourth leg 14 of the power router 101, respectively. The first leg 21, the second leg 22, the third leg 23, and the fourth leg 24 are connected to the outside via terminals 215, 225, 235, and 245, respectively. Operation modes of the power router 102 are similar to those of the power router 101, a description thereof will not be repeated.

In the present exemplary embodiment, the first leg 11 of the power router 101 and the first leg 21 of the power router 102 are connected to each other via the transmission line 1200. The second leg 22 is connected to a load 1033 via the terminal 225. The third leg 23 is connected to a storage battery 1034 via the terminal 235. The fourth leg 24 is connected to the utility grid 1035 via the terminal 245. Thus, the fourth leg 24 operates as a master leg.

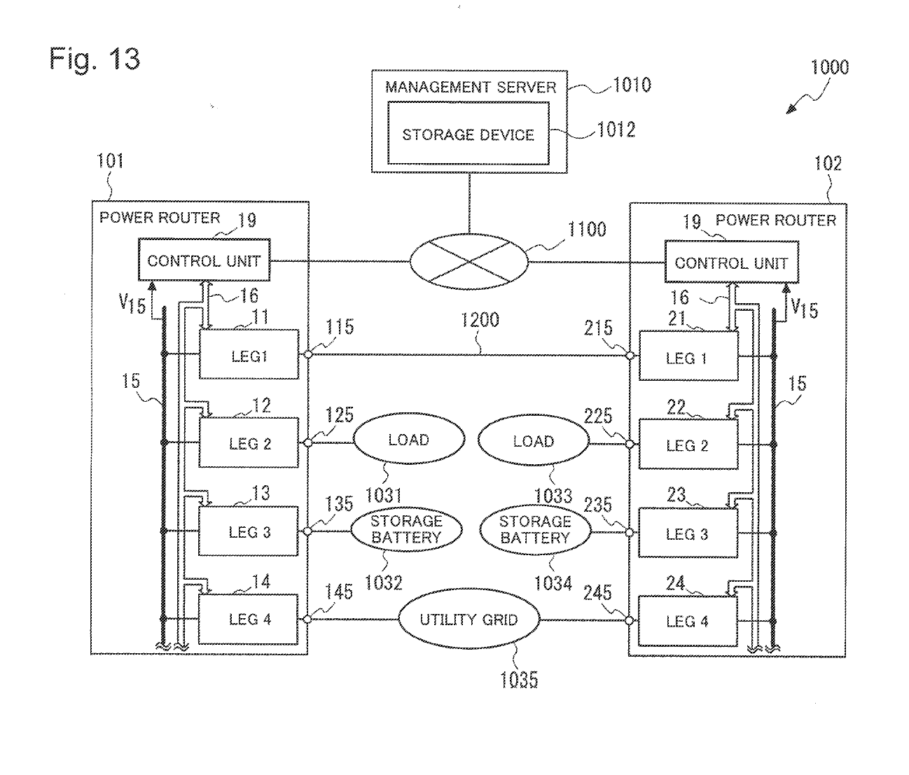

Next, the management server 1010 will be described. FIG. 13 is a block diagram illustrating a schematic configuration of the power network system 1000, which illustrates a configuration of the management server 1010. The management server 1010 can be configured, for example, as hardware such as a computer. The management server 1010 has a storage device 1012. The storage device 1012 stores information required for the control of power routers.

An operation of a power router according to the present exemplary embodiment will be described below in detail. As described above, the power router is normally provided with a plurality of legs. In the state in which a bus voltage is maintained at a predetermined value, when each of the plurality of legs performs power transmission and reception, it is necessary to balance transmission power and reception power in terms of an entire power router. In order to balance the transmission power and the reception power in terms of the entire power router, the control unit 19 has to control each leg.

In the present exemplary embodiment, based on the above-described assumption, the case where a plurality of master legs exist in one power router will be described. Providing a plurality of master legs has the following technical meaning. For example, there is considered a case where a power router is requested to transmit power to a destination requiring large power such as a high power household appliance. In this case, a designated-power transmission/reception leg or a stand-alone leg is connected to the destination. Therefore, in order to satisfy a request of the destination, it is necessary to use a high-output designated-power transmission/reception leg or stand-alone leg. In this case, in order to normally perform power transmission and reception of a leg other than a master leg of the power router, the capacity (rating) of the master leg has to be large. However, an increase in the capacity of the master leg causes an increase in the size and the cost of the master leg.

On the other hand, in the present exemplary embodiment, a plurality of master legs are provided. The entire capacity of the plurality of master legs can be increased thereby. However, when the plurality of master legs are provided, a special problem occurs as compared with the case where one master leg is provided. For example, when one master leg is provided, it is sufficient if the master leg performs power transmission and reception with the outside such that a bus voltage is simply maintained constant. However, when a plurality of master legs exist, if each of the master legs independently performs power transmission and reception similarly to the case where one master leg is provided, it is probable that an amount to be transmitted and received will be excessively increased. In this case, it is probable that overshoot and undershoot of a bus voltage, destabilization of the bus voltage, and extension of a time required for stabilizing the bus voltage will occur. Therefore, in the present exemplary embodiment, when a plurality of master legs perform power transmission and reception with the outside, amounts to be transmitted and received by the respective master legs are decided and set for the respective master legs, thereby preventing the occurrence of such a problem.

More specifically, in the present exemplary embodiment, in the state in which a plurality of master legs exist in one power router and a bus voltage is maintained to a predetermined value, the plurality of master legs are controlled to balance transmission power and reception power in terms of the entire power router.

When a target voltage value of the DC bus 15 is Vdc_{target}, an actually measured value of the DC bus 15 is Vdcₘₑₐₛᵤᵣₑ, and an actually measured value of an AC current flowing in the master leg is Iₘₑₐₛᵤᵣₑ, a target value I_{target} of the AC current to flow in the master leg can be defined by the following Equation 1 by using a coefficient s (s is a real number).

Equation 1

I_{target}=s(Vds_{target}−Vdcₘₑₐₛᵤᵣₑ)·Iₘₑₐₛᵤᵣₑ (1)

An AC voltage value Vac_{target} to be set for the master leg so as to achieve the target voltage value of the DC bus 15 at Vdc_{target} is expressed by the following Equation 2, by using the target value I_{target} of the AC current to flow in the master leg and a coefficient t (t is a real number).

Equation 2

Vac_{target}=t·I_{target} (2)

The aforementioned coefficient s and coefficient t are determined by the characteristics of a power router and a leg such as a structure and a manufacturing error. For example, the coefficient s and the coefficient t can be determined by actually measuring current/voltage characteristics of a leg.

In the master leg, the AC voltage value Vac_{target} to be set in the master leg is set, so that it is possible to control transmission power or reception power.

In a power router according to the present exemplary embodiment, a plurality of legs serve as master legs. Therefore, the control unit 19 needs to control the AC voltage value with respect to each of the plurality of master legs. A description will be provided below for power control which is performed for each of the plurality of master legs. For the sake of simplicity, the following description will be provided for the case where the control unit 19 controls transmission and reception power of the master legs.

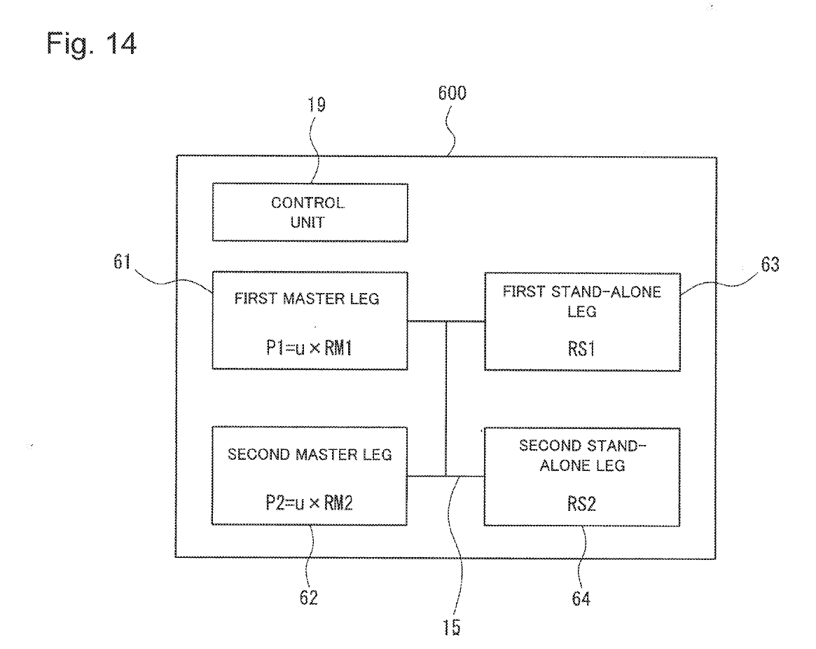

A description will be provided below for an example in which a power router having a plurality of master legs has two master legs and two stand-alone legs other than the master legs. FIG. 14 is a block diagram schematically illustrating a configuration of a power router 600 according to an exemplary embodiment 1.

The power router 600 has a first master leg 61, a second master leg 62, a first stand-alone leg 63, and a second stand-alone leg 64. A rated value of the first master leg 61 is represented as RM1, a rated value of the second master leg 62 is RM2, a rated value of the first stand-alone leg 63 is RS1, and a rated value of the second stand-alone leg 64 is RS2.

Although not illustrated, the first master leg 61 and the second master leg 62 are connected to a utility grid and a power supply such as a storage battery. Although not illustrated, the first stand-alone leg 63 and the second stand-alone leg 64 are connected to a power supply such as a storage battery, an exterior load or the like.

In the power router 600, the control unit 19 distributes power, which is to be received by or transmitted from a master leg, to the first master leg 61 and the second master leg 62 in response to the situation of power transmission and power reception of the first stand-alone leg 63 and the second stand-alone leg 64.

The transmission and reception power of the first stand-alone leg 63 and the second stand-alone leg 64 is designated, for example, by the management server 1010 in accordance with the control instruction 51. The transmission and reception power of the first stand-alone leg 63 and the second stand-alone leg 64 designated in accordance with the control instruction 51 is stored, for example, in the storage unit 191 of the control unit 19. The control unit 19 can thereby appropriately refer to the transmission and reception power of the first stand-alone leg 63 and the second stand-alone leg 64 stored in the storage unit 191.

An operation to be described below can be performed, for example, when the management server 1010 has newly designated the transmission and reception power of the first stand-alone leg 63 and the second stand-alone leg 64 or when the management server 1010 has changed the designation of the transmission and reception power of the first stand-alone leg 63 and the second stand-alone leg 64.

Hereinafter, power transmitted to the outside of the power router 600 from the first master leg 61, the second master leg 62, the first stand-alone leg 63, or the second stand-alone leg 64 is taken as negative. Power received by the first master leg 61, the second master leg 62, the first stand-alone leg 63, or the second stand-alone leg 64 from the outside of the power router 600 is taken as positive.

The transmission and reception power of the first master leg 61 is represented as P1 [kW]. When the first master leg 61 transmits power to the outside, P1 has a negative value (P1<0). When the first master leg 61 receives power from the outside, P1 has a positive value (P1>0).

The transmission and reception power of the second master leg 62 is represented as P2 [kW]. When the second master leg 62 transmits power to the outside, P2 has a negative value (P2<0). When the second master leg 62 receives power from the outside, P2 has a positive value (P2>0).

The transmission and reception power of the first stand-alone leg 63 is represented as W1 [kW]. When the first stand-alone leg 63 transmits power to the outside, W1 has a negative value (W1<0). When the first stand-alone leg 63 receives power from the outside, W1 has a positive value (W1>0).

The transmission and reception power of the second stand-alone leg 64 is represented as W2 [kW]. When the second stand-alone leg 64 transmits power to the outside, W2 has a negative value (W2<0). When the second stand-alone leg 64 receives power from the outside, W2 has a positive value (W2>0).

Accordingly, Wₜₒₜₐₗ, which is the total power transmitted/received by the first stand-alone leg 63 and the second stand-alone leg 64 is (W1+W2) [kW]. In this case, when Wₜₒₜₐₗ>0, it is necessary to transmit power to the outside via a master leg in order to maintain the voltage of the DC bus 15 to the target voltage value Vdc_{target}. When Wₜₒₜₐₗ<0, it is necessary to receive power from the outside via the master leg in order to maintain the voltage of the DC bus 15 to the target voltage value Vdc_{target}. The control unit 19 distributes transmission power or reception power to the first master leg 61 and the second master leg 62, so that power transmission and reception are performed.

First, the control unit 19 calculates a coefficient u (also called a first coefficient) for defining the output of the first master leg 61 and the second master leg 62. The coefficient u is calculated by the following Equation.

$$\begin{matrix}Equation 3 & \\ u = \vert \frac{W 1 + W 2}{RM 1 + RM 2} \vert & ( 3 )\end{matrix}$$

That is, the coefficient u is calculated by dividing the sum of the transmission and reception power of legs other than the master legs by the sum of the rating of the master legs.

As expressed by Equation 4 below, the control unit 19 multiplies the rating RM1 of the first master leg 61 by the coefficient u, thereby calculating the power instruction value P1 of the first master leg 61.

Equation 4

P1=u·RM1 (4)

As expressed by Equation 5 below, the control unit 19 multiplies the rating RM2 of the second master leg 62 by the coefficient u, thereby calculating the power instruction value P2 of the second master leg 62.

Equation 5

P2=u·RM2 (5)

Detailed examples (cases 1 to 4) will be described below.

### Case 1

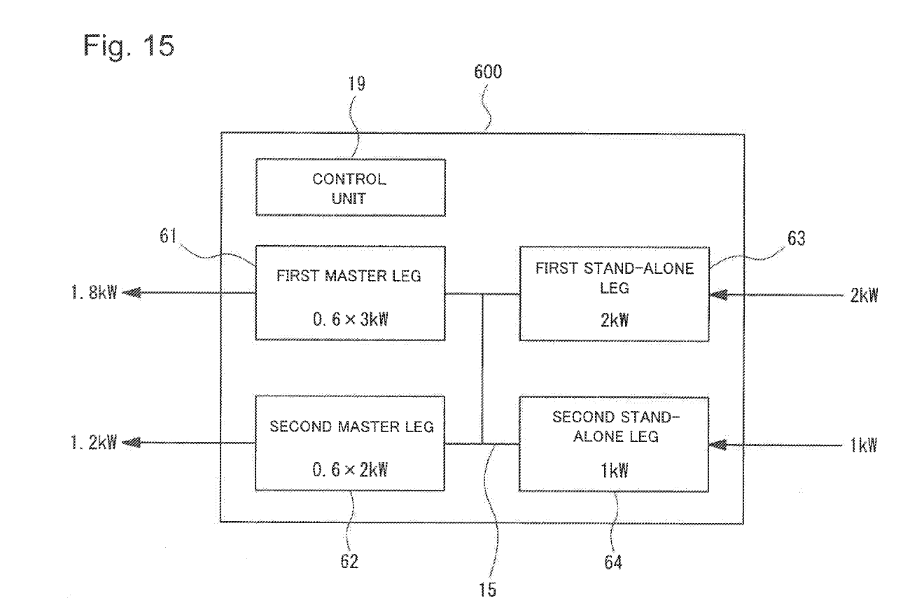

The case where power received in the first stand-alone leg 63 is 2 [kW] (W1=2 [kW]) and power received in the second stand-alone leg 64 is 1 [kW] (W2=1 [kW]) will be described. FIG. 15 is a diagram illustrating the power router 600 when power received in the first stand-alone leg 63 is 2 kW (W1=2 kW) and power received in the second stand-alone leg 64 is 1 kW (W2=1 kW). In this case, the power router 600 receives power of 3 [kW] from the outside. Thus, the power router 600 has to be able to transmit power of 3 [kW] at maximum via the master legs. In this case, the control unit 19 calculates the coefficient u from Equation 3 above as expressed by the following Equation 6.

$$\begin{matrix}Equation 6 & \\ u = \vert \frac{2 + 1}{3 + 2} \vert = 0.6 & ( 6 )\end{matrix}$$

In this case, the coefficient u is 0.6. Thus, by Equation 4 above, the transmission power of the first master leg 61 is 1.8 [kW] (=0.6×3 [kW]). By Equation 5 above, the transmission power of the second master leg 62 is 1.2 [kW] (=0.6×2 [kW]).

### Case 2

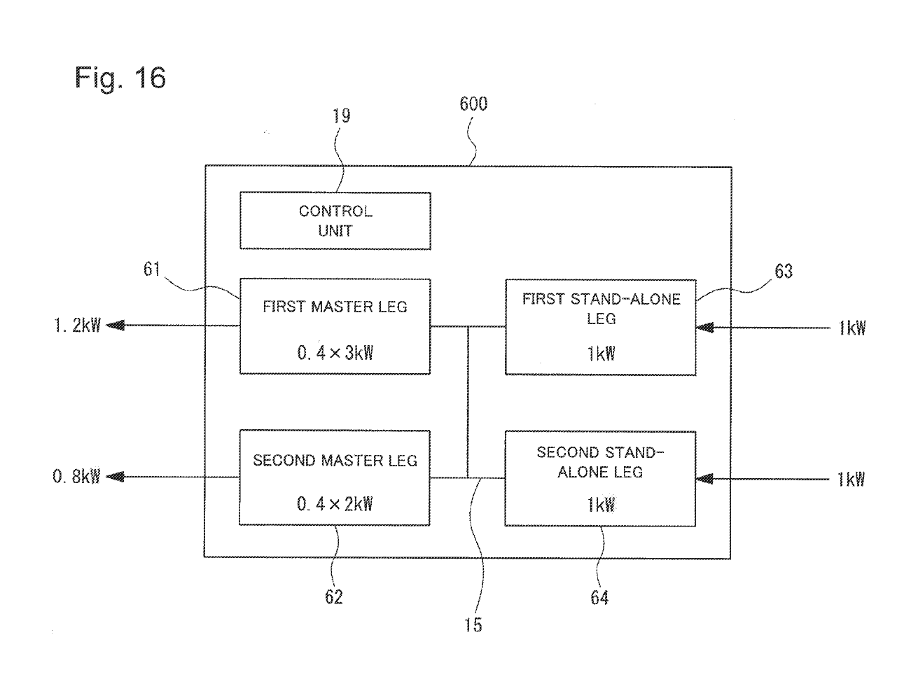

The case where power received in the first stand-alone leg 63 is 1 [kW] (W1=1 [kW]) and power received in the second stand-alone leg 64 is 1 [kW] (W2=1 [kW]) will be described. FIG. 16 is a diagram illustrating the power router 600 when power received in the first stand-alone leg 63 is 1 kW (W1=1 kW) and power received in the second stand-alone leg 64 is 1 kW (W2=1 kW). In this case, the power router 600 receives power of 2 [kW] from the outside. Thus, the power router 600 has to be able to transmit power of 2 [kW] at maximum via the master leg. In this case, the control unit 19 calculates the coefficient u from Equation 3 above as expressed by the following Equation 7.

$$\begin{matrix}Equation 7 & \\ u = \vert \frac{1 + 1}{3 + 2} \vert = 0.4 & ( 7 )\end{matrix}$$

In this case, the coefficient u is 0.6. Thus, by Equation 4 above, the transmission power of the first master leg 61 is 1.2 [kW] (=0.4×3 [kW]). By Equation 5 above, the transmission power of the second master leg 62 is 0.8 [kW] (=0.4×2 [kW]).

When, for example, the setting of the transmission and reception power of the first stand-alone leg 63 and the second stand-alone leg 64 has been changed from the case 1 to the case 2 by an instruction of the management server 1010, the control unit 19 can change the coefficient u from 0.6 to 0.4.

### Case 3

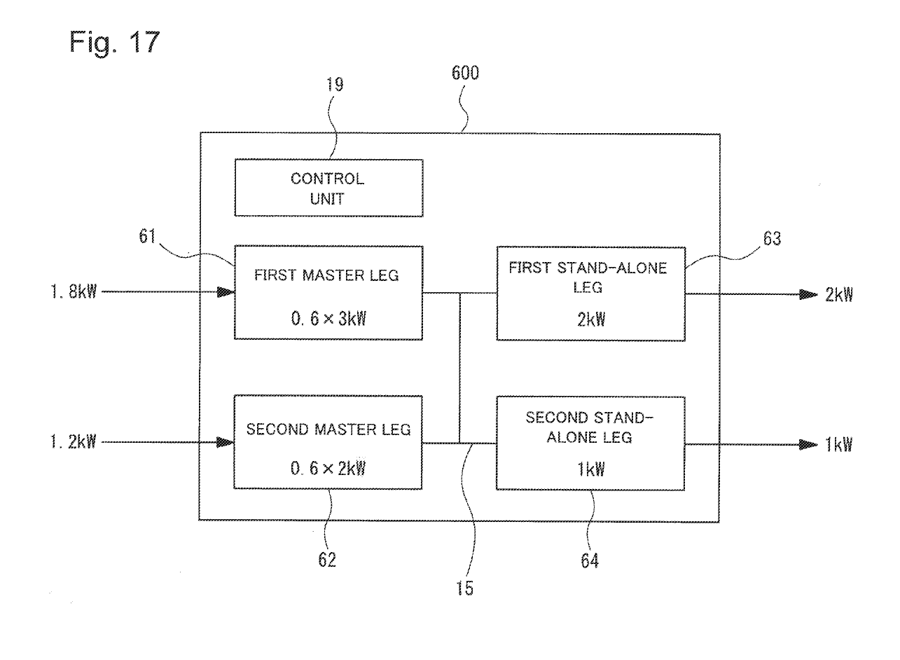

The case where power transmitted in the first stand-alone leg 63 is 2 [kW] (W1=−2 [kW]) and power transmitted in the second stand-alone leg 64 is 1 [kW] (W2=−1 [kW]) will be described. FIG. 17 is a diagram illustrating the power router 600 when power transmitted in the first stand-alone leg 63 is 2 [kW] (W1=−2 [kW]) and power transmitted in the second stand-alone leg 64 is 1 [kW] (W2=−1 [kW]). In this case, the power router 600 receives power of 3 [kW] from the outside. Thus, the power router 600 has to be able to receive power of 3 [kW] at maximum via the master legs. In this case, the control unit 19 calculates the coefficient u from Equation 3 above as expressed by the following Equation 8.

$$\begin{matrix}Equation 8 & \\ u = \vert \frac{- 2 - 1}{3 + 2} \vert = 0.6 & ( 8 )\end{matrix}$$

In this case, the coefficient u is 0.6. Thus, by Equation 4 above, the reception power of the first master leg 61 is 1.8 [kW] (=0.6×3 [kW]). By Equation 5 above, the reception power of the second master leg 62 is 1.2 [kW] (=0.6×2 [kW]).

### Case 4

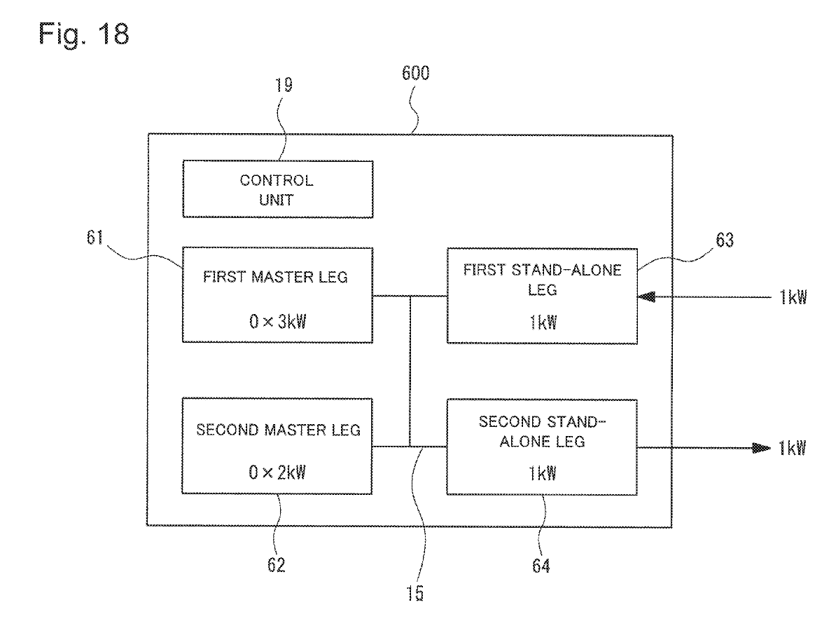

The case where power received in the first stand-alone leg 63 is 1 [kW] (W1=1 [kW]) and power transmitted in the second stand-alone leg 64 is 1 [kW] (W2=−1 [kW]) will be described. FIG. 18 is a diagram illustrating the power router 600 when power received in the first stand-alone leg 63 is 1 [kW] (W1=1 [kW]) and power transmitted in the second stand-alone leg 64 is 1 [kW] (W2=−1 [kW]). In this case, the power router 600 balances transmission power and reception power between the first stand-alone leg 63 and the second stand-alone leg 64. Thus, the power router 600 does not need to perform power transmission and reception via the master legs. In this case, the control unit 19 calculates the coefficient u from Equation 3 above as expressed by the following Equation 9.

$$\begin{matrix}Equation 9 & \\ u = \vert \frac{1 - 1}{3 + 2} \vert = 0 & ( 9 )\end{matrix}$$

In this case, the coefficient u is 0. Thus, by Equation 4 above, the reception power of the first master leg 61 is 0 [kW] (=0×3 [kW]). By Equation 5 above, the reception power of the second master leg 62 is 0 [kW] (=0×2 [kW]). By the operation, it can be understood that the first master leg 61 and the second master leg 62 perform no power transmission and reception.

Furthermore, the case with a generalized configuration of a power router will be described. The number of master legs of the power router is represented as N (N is an integer equal to or more than 2) and the number of legs other than the master legs is M (M is an integer equal to or more than 1). In this case, Equation 3 above can be generalized as expressed by the following Equation 10.

$$\begin{matrix}Equation 10 & \\ u = \vert \frac{{\sum }_{i = 1}^{M} Wi}{{\sum }_{j = 1}^{N} RMj} \vert & ( 10 )\end{matrix}$$

In this case, Equation 4 and Equation 5 above can be generalized as expressed by the following Equation 11. As expressed by Equation 10 above, j is an integer satisfying the relation of 1≦j≦N.

Equation 11

Pj=u·RMj (11)

So far, according to the present configuration, when a plurality of master legs are used in a power router, power to be transmitted and received via the master legs can be distributed to the respective master legs. A specific power designation value is set for each of the plurality of master legs so that it is possible to maintain a bus voltage to a proper value.

Legs other than master legs include the above-described AC through leg. However, the AC through leg simply passes the transmission and reception power of another stand-alone leg or designated-power transmission/reception leg and performs no direct power transmission and reception with the outside. Therefore, when the transmission and reception power passing through the AC through leg is included in the sum (the numerator of the right side of Equation 10 above) of the transmission and reception power of the legs other than master legs, the transmission and reception power of a stand-alone leg or a designated-power transmission/reception leg connected to the AC through leg is doubly counted. Thus, when calculating the sum (the numerator of the right side of Equation 10 above) of the transmission and reception power of the legs other than master legs, the transmission and reception power passing through the AC through leg is to be excluded.

### Exemplary Embodiment 2

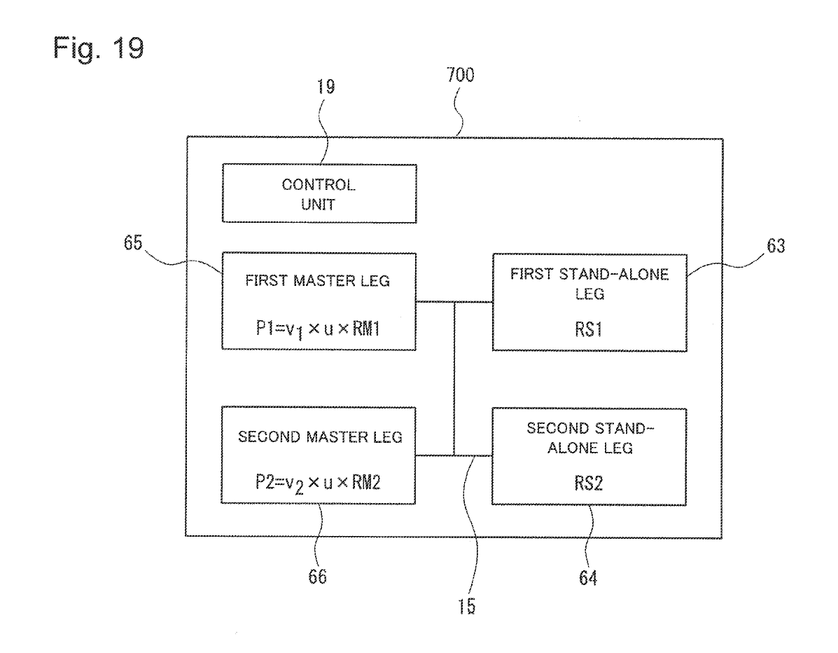

Next, a power router 700 according to an exemplary embodiment 2 will be described. FIG. 19 is a block diagram schematically illustrating a configuration of the power router 700 according to the exemplary embodiment 2. The power router 700 has a configuration in which the first master leg 61 and the second master leg 62 of the power router 600 according to the exemplary embodiment 1 have been replaced with a first master leg 65 and a second master leg 66, respectively.

In the power router 600 according to the exemplary embodiment 1, the ratings of a plurality of legs have been multiplied by the coefficient u. On the other hand, in the power router 700 according to the present exemplary embodiment, a priority is predetermined among a plurality of legs of the power router 900. The control unit 19 sets a larger power designation value in a master leg with a high priority. The priority is a value indicating the importance of a leg, and for example, is expressed by a numeral value.

In the present exemplary embodiment, the control unit 19 multiplies the rating RM1 of the first master leg 65 by an adjustment coefficient v₁ (also called a second coefficient) as well as the coefficient u. Thus, the power instruction value P1 of the first master leg 65 is expressed by the following Equation 12.

Equation 12

P1=v₁·u·RM1 (12)

The control unit 19 multiplies the rating RM2 of the second master leg 66 by an adjustment coefficient v₂ (also called a second coefficient) as well as the coefficient u. Thus, the power instruction value P2 of the second master leg 66 is expressed by the following Equation 13.

Equation 13

P2=v₂·RM2 (13)

Here, to a master leg with a higher priority is allocated a larger value of adjustment coefficient which is multiplied into the rating of the leg. For example, when the priority of the first master leg 65 is higher than that of the second master leg 66, v₁>v₂. Bearing in mind, however, that power transmission and reception cannot be performed for the first master leg 65 and the second master leg 66 beyond the ratings of these legs, it is necessary to set v₁ such that 0<(v₁×u)<1 and set v₂ such that 0<(v₂×u)<1.

Furthermore, the case with a generalized configuration of a power router will be described. The number of master legs of the power router is represented as N (N is an integer equal to or more than 2) and the number of legs other than the master legs is M (M is an integer equal to or more than 1). In this case, Equation 12 and Equation 13 above can be generalized as expressed by the following Equation 14. As expressed by Equation 10 above, j is an integer satisfying the relation of 1≦j≦N.

Equation 14

Pj=vⱼ·u·RMj (14)

It is necessary to set vⱼ such that 0<(vⱼ×u)<1.

So far, according to the present configuration, it is possible to adjust the power designation value of a master leg in response to the priory among each of a plurality of master legs. Thus it is possible to determine the power designation value so as to correspond to the characteristics of each of the plurality of master legs.

The priority can be set as follows. For example, it is possible to place a higher priority on a power leg connected to a power supply with high stability such as a commercial power supply system. It is possible thereby to expect stable supply of power to a power router.

For example, it is also possible to change a priority in accordance with time. By such an operation, a power supply source with a time-variable rates system, such as night hour rates, may be effectively utilized to reduce electricity cost.

For example, it is also possible to place a higher priority on a master leg with a larger rating. By such an operation, the master leg with a larger rating is mainly used, so that it is possible to achieve stable power transmission and reception. The priority of the master leg may be set by the management server 1010 or the control unit 19.

For example, it is also possible to place a higher priority on a master leg with a shorter accumulated operation time. By such an operation, it is possible to reduce a load of the master leg with a longer accumulated operation time and to even out accumulated loads among a plurality of master legs. As a consequence, it is possible to reduce a failure rate and extend a lifetime of a power router.

### Other Embodiments

The present invention is not limited to the aforementioned exemplary embodiments and can be appropriately changed without departing from the spirit thereof. For example, although the control unit 19 is described as the configuration of hardware in the foregoing exemplary embodiments, the present invention is not limited thereto. For example, the control unit 19 can be configured by a computer which performs any processing with a CPU (Central Processing Unit) executing a computer program. Furthermore, a control device is installed in a power conversion unit of a leg, and the control device, for example, is configured as a dynamic reconfiguration logic (FPGA: Field Programmable Gate Array). A control program of the FPGA is adapted to a mode of a leg and operated. By the operation, the FPGA is rewritten in accordance with the type and operation of a leg, so that it is possible to perform control suitable to the operation mode of the leg, thereby reducing hardware capacity requirement and cost. Furthermore, the above-described program is stored by using a non-transitory computer readable medium of various types and can be supplied to a computer. Non-transitory computer readable media includes substantive recording media (tangible storage media) of various types. Examples of the non-transitory computer readable media include magnetic recording media (for example, a flexible disk, a magnetic tape, and a hard disk drive), a magnetic optical recording medium (for example, a magnetic optical disk), a CD-ROM (Read Only Memory) a CD-R, a CD-R/W, semiconductor memories (for example, a mask ROM, a PROM (Programmable ROM), an EPROM (Erasable PROM), a flash ROM, and a RAM (Random Access Memory)). A program may be supplied to a computer by any of transitory computer readable medium of various types. Examples of the transitory computer readable medium include an electric signal, a light signal, and an electromagnetic wave. With the transitory computer readable medium, a program can be supplied to a computer via a wired communication path such as an electric line or an optical fiber or a wireless communication path.

In the exemplary embodiments 1 and 2, the number of master legs is 2, but this is for illustrative purposes only. The number of master legs can be 3 or more. Furthermore, in the exemplary embodiments 1 and 2, the number of legs other than the master legs is assumed 2, but this is for illustrative purposes only. The number of legs other than the master legs can be any number equal to or more than 1. Furthermore, the legs other than the master legs may be stand-alone legs or designated-power transmission/reception legs.

So far, the present invention has been described with reference to the exemplary embodiments. However, the present invention is not limited thereto. Various modifications which can be understood by a person skilled in the art can be made to the configuration and details of the present invention within the scope of the invention.

This application claims priority based on Japanese Patent Application No. 2014-4919 filed on Jan. 15, 2014, the contents of which are incorporated herein in its entirety by reference.

### REFERENCE SIGNS LIST

BL branch line
D1 to D6 diode
INF information
MODE operation mode designation information
P1, P2 power instruction value
Q1 to Q6 transistor
RM1, RM2 rating
SA1, SD1 waveform instruction signal
SA2, SD2 reading signal
SCON control signal
SIG1 switching control signal
V₁₅ bus voltage
Vr detection value
11, 21 first leg
12, 22 second leg
13, 23 third leg
14, 24 fourth leg
51, M101, M201, M301, M401, M501, M601, DC bus
16 communication bus
17 voltage sensor
19 control unit
51 control instruction
52 information
60 through leg
61, 65 first master leg
62, 66 second master leg
63 first stand-alone leg
64 second stand-alone leg
71A, 71B power transmission line
72 distribution line
100, 101, 102, 170, 200, 300, 400, 600, 700, 841 to 844 power router
821 to 824 power cell
111, 121, 131, 141 power conversion unit
112, 122, 132, 142, 162 current sensor
113, 223, 133, 143, 163 switch
114, 224, 134, 144, 164 voltage sensor
115, 125, 135, 145, 165, 215, 225, 235, 245 connection terminal
191 storage unit
192 operation mode management unit
193 power conversion instruction unit
194 DA/AD conversion unit
195 sensor value reading unit
196 control instruction database
197 leg identification information database
110, 210, 220, 320, 420, 560 master leg
210, 410 stand-alone leg
250 AC through leg
610 designated-power transmission/reception leg
810, 1000, 2000 power network system
811, 1035, 1035A to 1035C utility grid
812 large-scale power plant
831 house
832 building
833 solar power panel
834 wind power generator
835, 1032, 1034 storage battery
850, 1010, 1020 management server
860, 1100 communication network
1011 power conversion unit
1012 storage device
1031, 1033 load
1200, 1201 to 1203, 1211 to 1213 transmission line
1300 communication line

1. A power router comprising:
a plurality of master legs;
one or more legs other than the master legs; and
a control unit that controls power transmitted/received by each of the plurality of master legs based on power transmitted/received by the one or more legs other than the master legs.

2. The power router according to claim 1, wherein
the control unit controls the power transmitted/received by each of the plurality of master legs such that a sum of the power transmitted/received by the one or more legs other than the master legs coincides with a sum of the power transmitted/received by each of the plurality of master legs.

3. The power router according to claim 2, wherein
the control unit allows each of the plurality of master legs to perform power transmission when the power router receives power via the one or more legs other than the master legs, and
allows each of the plurality of master legs to perform power reception when the power router transmits power via the one or more legs other than the master legs.

4. The power router according to claim 1, wherein
the control unit multiplies a rating of each of the plurality of master legs by a first coefficient, thereby deciding the power transmitted/received by each of the plurality of master legs.

5. The power router according to claim 4, wherein
the first coefficient has a value equal to or more than 0 and equal to or less than 1.

6. The power router according to claim 4 or 5, wherein the first coefficients multiplied into the rating of each of the plurality of master legs are equal values.

7. The power router according to claim 6, wherein
the control unit calculates the first coefficient by dividing a sum value of the power transmitted/received by each of the plurality of master legs by a sum value of the ratings of the plurality of master legs.

8. The power router according to claim 4, wherein the control unit multiplies the rating of each of the plurality of master legs by the first coefficient and a second coefficient, thereby deciding the power transmitted/received by each of the plurality of master legs.

9. The power router according to claim 8, wherein the control unit determines the second coefficient based on a priority of each of the plurality of master legs.

10. The power router according to claim 9, wherein the control unit increases the second coefficient as the priority is high with respect to each of the plurality of master legs.

11. The power router according to claim 10, wherein a value obtained by multiplying the first coefficient and the second coefficient of each of the plurality of master legs is a value equal to or more than 0 and equal to or less than 1.

12. A power network system comprising:
a power router; and
a management server that controls power transmission and reception of the power router,
wherein the power router includes:
a plurality of master legs;
one or more legs other than the master legs; and
a control unit that controls power transmitted/received by each of the plurality of master legs based on power transmitted/received by the one or more legs other than the master legs, in response to an instruction from the management server.

13. A control method of a power router, comprising the steps of:
referring to power transmitted/received by one or more legs other than a master leg; and
controlling power transmitted/received by each of a plurality of master legs based on the power transmitted/received by the one or more legs other than the master leg.

14. A non-transitory computer readable medium storing a control program of a power router, which causes a computer to perform:
a process of referring to power transmitted/received by one or more legs other than a master leg; and
a process of controlling power transmitted/received by each of a plurality of master legs based on the power transmitted/received by the one or more legs other than the master leg.
